(19) United States
(12) Patent Application Publication
(10) Pub. No.: US 2026/0100767 A1
(43) Pub. Date: Apr. 9, 2026

(54) METHOD FOR TRANSMITTING INFORMATION IN QUANTUM COMMUNICATION SYSTEM. AND DEVICE THEREFOR

(71) Applicant: LG Electronics Inc., Seoul (KR)

(72) Inventors: Hojae LEE, Seoul (KR); Sangrim LEE, Seoul (KR); Jayeong KIM, Seoul (KR); Byungkyu AHN, Seoul (KR)

(21) Appl. No.: 19/114,325

(22) PCT Filed: Sep. 21, 2022
(86) PCT No.: PCT/KR2022/014101

§ 371 Date: Mar. 21, 2025

(51) Int. Cl. H04B 10/70

(52) U.S. Cl. CPC H04B 10/70

(57) ABSTRACT

The present specification provides a method for transmitting information in a quantum communication system.

More specifically, the method is characterized by comprising the steps of: receiving, from a receiving end, a signal for synchronizing with the receiving end; receiving system information from the receiving end; performing a random access procedure with the receiving end to establish an initial connection thereto; receiving configuration information from the receiving end, the configuration information comprising information on the number of quantized qubit states obtained by quantizing the states of qubits for transmission of classical information; modulating the classical information depending on the qubit, the classical information being modulated on the basis of a predefined mapping relationship based on (i) the classical information and (ii) the states of qubits, wherein the mapping relationship comprises a mapping relationship between (i) bit values that the classical information may have and (ii) the quantized qubit states; and, transmitting, to the receiving end, the qubit based on the modulated classical information.

### TECHNICAL FIELD

The present disclosure relates to a quantum communication system, and more particularly, to a method for transmitting information in a quantum communication system, and a device therefor.

### BACKGROUND ART

Wireless communication systems have been widely deployed to provide various types of communication services such as voice and data. In general, the wireless communication system is a multiple access system capable of supporting communication with multiple users by sharing available system resources (bandwidth, transmission power, etc.). Examples of the multiple access system include a code division multiple access (CDMA) system, a frequency division multiple access (FDMA) system, a time division multiple access (TDMA) system, a space division multiple access (SDMA), an orthogonal frequency division multiple access (OFDMA) system, a single carrier frequency division multiple access (SC-FDMA) system, an interleave division multiple access (IDMA), etc., In addition, research is ongoing on quantum communication, a next-generation communication technology that can overcome the limitations of existing information and communication, such as security and ultra-high-speed computing, by applying quantum mechanical properties to an information and communication field. Quantum communication provides a means to generate, transmit, process, and store information in a form of a superposition of 0 and 1, unlike conventional communication which is based on binary bit information. In existing communication technologies, wavelengths and amplitudes are used to transmit information between a transmitting terminal and a receiving terminal, but in quantum communication, photons, the smallest unit of light, are used to transmit information between the transmitting terminal and the receiving terminal.

### DISCLOSURE OF INVENTION

### Technical Problem

An object of the present disclosure is to provide a method for transmitting information in a quantum communication system, and a device therefor.

Further, an object of the present disclosure is to provide a method for predefining a mapping table between a quantized state of a quantized qubit and classical bit information through quantization of a quantum state that a qubit may have for information transmission through a single qubit composed of a two-dimensional Hilbert space, and a device therefor.

In addition, an object of the present disclosure to provide a method for setting an appropriate mapping table and a device therefore, when transmitting and receiving information based on a mapping table between a quantized state of a quantized qubit and classical bit information between a transmitting terminal a receiving terminal.

The technical objects of the present disclosure are not limited to the aforementioned technical objects, and other technical objects, which are not mentioned above, will be apparently appreciated by a person having ordinary skill in the art from the following description.

### Solution to Problem

The present disclosure provides a method for transmitting information in a quantum communication system, and a device therefor.

More specifically, in the present disclosure, the method for transmitting information by a transmitting terminal in a quantum communication system includes: receiving, from a receiving terminal, a signal for synchronizing with the receiving terminal; receiving system information from the receiving terminal; performing a random access procedure with the receiving terminal to establish an initial connection to the receiving terminal; receiving configuration information from the receiving terminal, in which the configuration information includes information for the number of quantized qubit states obtained by quantizing state of qubit for transmission of classical information; modulating the classical information based on the qubit, in which the classical information is modulated based on a predefined mapping relationship based on (i) the classical information and (ii) the state of the qubit, and the mapping relationship includes mapping relationships between (i) bit values that the classical information may have and (ii) the quantized qubit states; and transmitting, to the receiving terminal, the qubit based on the modulated classical information.

Further, in the present disclosure, the state of the qubit is determined based on a first qubit basis and a second qubit basis.

In addition, in the present closure, the first qubit basis is multiplied by a real value, and the second qubit basis is multiplied by an imaginary value.

Further, in the present disclosure, a pair of (i) the real value multiplied by the first qubit basis and (ii) the imaginary value multiplied by the second qubit basis are defined to be located on a surface of a sphere in a three-dimensional space.

In addition, in the present closure, the mapping relationship is a mapping relationship between (i) pairs of the real value and the imaginary value, and (ii) the bit values that the classical information may have.

Further, in the present disclosure, the number of quantized qubit states is N, and

the N is a non-negative integer.

Further, in the present disclosure, the method further includes exchanging information for the N with the receiving terminal.

In addition, in the present closure, the modulating the classical information based on the qubit for transmitting the classical information is performed based on the information for the N.

Further, in the present disclosure, the exchanging the information for the N with the receiving terminal includes transmitting the information for the N to the receiving terminal.

Further, in the present disclosure, the exchanging the information for the N with the receiving terminal includes

receiving the configuration information, and the information for the N is included in the configuration information.

Further, in the present disclosure, a transmitting terminal performing an authentication in a quantum communication system includes: a transmitter for transmitting a radio signal; a receiver for receiving the radio signal; at least one processor; and at least one computer memory operably connectable to the at least one processor, and storing instructions of performing operations when executed by the at least one processor, and the operations include: receiving, from a receiving terminal, a signal for synchronizing with the receiving terminal; receiving system information from the receiving terminal: performing a random access procedure with the receiving terminal to establish an initial connection to the receiving terminal; receiving configuration information from the receiving terminal, in which the configuration information includes information for the number of quantized qubit states obtained by quantizing state of qubit for transmission of classical information; modulating the classical information based on the qubit, in which the classical information is modulated based on a predefined mapping relationship based on (i) the classical information and (ii) the state of the qubit, and the mapping relationship includes mapping relationships between (i) bit values that the classical information may have and (ii) the quantized qubit states; and transmitting, to the receiving terminal, the qubit based on the modulated classical information.

In addition, in the present disclosure, a method for receiving information by a receiving terminal in a quantum communication system includes: transmitting, to a transmitting terminal, a signal for synchronizing with the transmitting terminal: transmitting system information to the transmitting terminal; performing a random access procedure with the transmitting terminal to establish an initial connection of transmitting terminal to the transmitting terminal; transmitting configuration information to the transmitting terminal, in which the configuration information includes information for the number of quantized qubit states obtained by quantizing state of qubit for transmission of classical information; and receiving, from the transmitting terminal, the qubit generated by modulating the classification information based on a predefined mapping relationship based on (i) the classical information and (ii) the state of the qubit, in which the mapping relationship includes mapping relationships between (i) bit values that the classical information may have and (ii) the quantized qubit states.

Further, in the present disclosure, a receiving terminal performing an authentication in a quantum communication system includes: a transmitter for transmitting a radio signal; a receiver for receiving the radio signal: at least one processor; and at least one computer memory operably connectable to the at least one processor, and storing instructions of performing operations when executed by the at least one processor, and the operations include: transmitting, from a transmitting terminal, a signal for synchronizing with the transmitting terminal; transmitting system information to the transmitting terminal: performing a random access procedure with the transmitting terminal to establish an initial connection of the transmitting terminal to receiving terminal: transmitting configuration information to the transmitting terminal, in which the configuration information includes information for the number of quantized qubit states obtained by quantizing state of qubit for transmission of classical information; and receiving, from the transmitting terminal, the qubit generated by modulating the classification information based on a predefined mapping relationship based on (i) the classical information and (ii) the state of the qubit, in which the mapping relationship includes mapping relationships between (i) bit values that the classical information may have and (ii) the quantized qubit states.

Further, in the present disclosure, in a non-transitory computer readable medium (CRM) storing one or more instructions, one or more instructions executable by one or more processors include: receiving, from a receiving terminal, a signal for synchronizing with the receiving terminal: receiving system information from the receiving terminal; performing a random access procedure with the receiving terminal to establish an initial connection to the receiving terminal; receiving configuration information from the receiving terminal, in which the configuration information includes information for the number of quantized qubit states obtained by quantizing state of qubit for transmission of classical information: modulating the classical information based on the qubit, in which the classical information is modulated based on a predefined mapping relationship based on (i) the classical information and (ii) the state of the qubit, and which the mapping relationship includes mapping relationships between (i) bit values that the classical information may have and (ii) the quantized qubit states; and transmitting, to the receiving terminal, the qubit based on the modulated classical information.

Further, in the present disclosure, a device includes: one or more memories and one or more processors functionally connected to the one or more memories, and the one or more processors allow the device to control to receive, from a receiving terminal, a signal for synchronizing with the receiving terminal, control to receive system information from the receiving terminal, control to perform a random access procedure with the receiving terminal to establish an initial connection to the receiving terminal, control to receive configuration information from the receiving terminal, in which the configuration information includes information for the number of quantized qubit states obtained by quantizing state of qubit for transmission of classical information; control to modulate the classical information based on the qubit, in which the classical information is modulated based on a predefined mapping relationship based on (i) the classical information and (ii) the state of the qubit, and the mapping relationship includes mapping relationships between (i) bit values that the classical information may have and (ii) the quantized qubit states, and control to transmit, to the receiving terminal, the qubit based on the modulated classical information.

### Advantageous Effects of Invention

According to the present disclosure, there is an effect in that information can be transmitted in a quantum communication system.

Further, according to the present disclosure, there is an effect of enabling transmission of classical 1-bit information though a single qubit composed of a two-dimensional Hilbert space.

In addition, according to the present disclosure, there is an effect of being able to transmit N qubit states or log 2(N) bits by using a single qubit through N-QSM.

Advantages which can be obtained in the present disclosure are not limited to the aforementioned effects and other unmentioned effects will be clearly understood by those skilled in the art from the following description.

### BRIEF DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing a method of processing a transmitted signal applicable to the present disclosure.

FIG. 4 is a view showing another example of a wireless device applicable to the present disclosure.

FIG. 5 is a view showing an example of a hand-held device applicable to the present disclosure.

FIG. 6 is a view showing physical channels applicable to the present disclosure and a signal transmission method using the same.

FIG. 7 is a view showing the structure of a radio frame applicable to the present disclosure.

FIG. 8 is a view showing a slot structure applicable to the present disclosure.

FIG. 9 is a view showing an example of a communication structure providable in a 6G system applicable to the present disclosure.

FIG. 10 is a view showing an example of a configuration of a quantum network.

FIG. 11 is a view showing examples of a configuration of a quantum communication system according to a type of information.

FIG. 12 is a view showing an example of a qubit state on a Bloch sphere.

FIG. 13 is a view showing an example of uniform quantization methods.

FIG. 14 is a view showing an example of 2-QSM constellations plotted on a surface of the Bloch sphere.

FIG. 15 is a view showing an example of 4-QSM constellations plotted on the surface of the Bloch sphere.

FIG. 16 is a view showing an example of 8-QSM constellations plotted on the surface of the Bloch sphere.

FIG. 17 is a view showing an example of 16-QSM constellations plotted on the surface of the Bloch sphere.

FIG. 18 is a view showing an example of 64-QSM constellations plotted on the surface of the Bloch sphere.

FIG. 19 is a view showing an example of 4-QSM constellations plotted on the surface of the Bloch sphere.

FIG. 20 is a view showing an example of 8-QSM constellations plotted on the surface of the Bloch sphere.

FIG. 21 is a view showing an example of 16-QSM constellations plotted on the surface of the Bloch sphere.

FIG. 22 is a view showing an example of 16-QSM constellations plotted on the surface of the Bloch sphere.

FIG. 23 is a view showing an example of an overall transmitting/receiving terminal structure view of a QSM system.

FIG. 24 is a view showing an example of a configuration of a quantum state modulator.

FIG. 25 is a view showing an example of a configuration of a Faraday rotator.

FIG. 26 is a view showing an example of a configuration of a quantum state demodulator in a receiving terminal.

FIGS. 27 and 28 are view showing an example of a quantum cloning scheme.

FIG. 29 is a view showing an example of the configuration of the quantum state demodulator in the receiving terminal.

FIG. 30 is a view showing another example of the configuration of the quantum state demodulator in the receiving terminal.

FIG. 31 is a view showing an example of a configuration of a quantum state estimator of a quantum decoder.

FIG. 32 is a view showing yet another example of the configuration of the quantum state estimator of the quantum decoder.

FIG. 33 is a view showing still yet another example of the configuration of the quantum state estimator of the quantum decoder.

FIG. 34 is a view showing still yet another example of the configuration of the quantum state estimator of the quantum decoder.

FIG. 35 is a flowchart showing an example in which an information transmission method proposed by the present disclosure is performed by a transmitting terminal.

FIG. 36 is a flowchart showing an example in which the information transmission method proposed by the present disclosure is performed by a receiving terminal.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA). Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail. LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

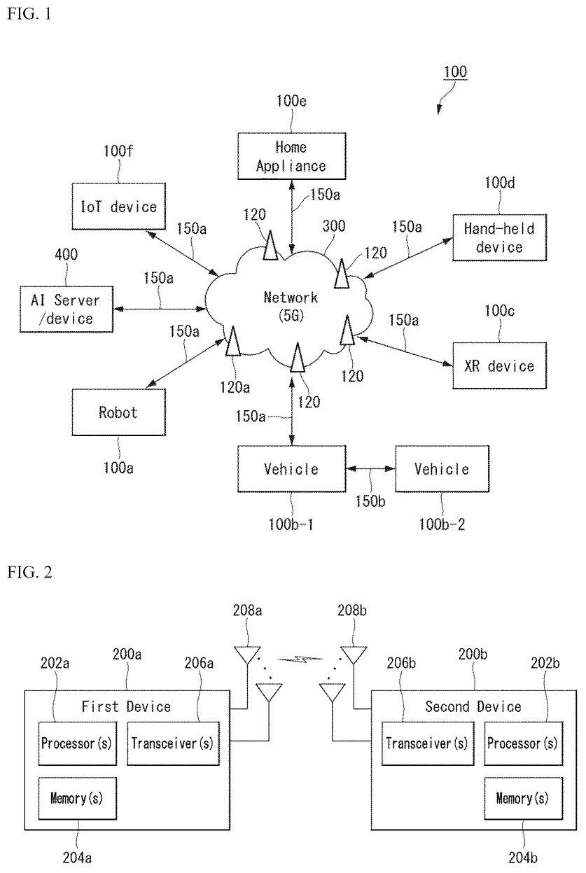

FIG. 1 is a view showing an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control). RLC (radio link control). PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

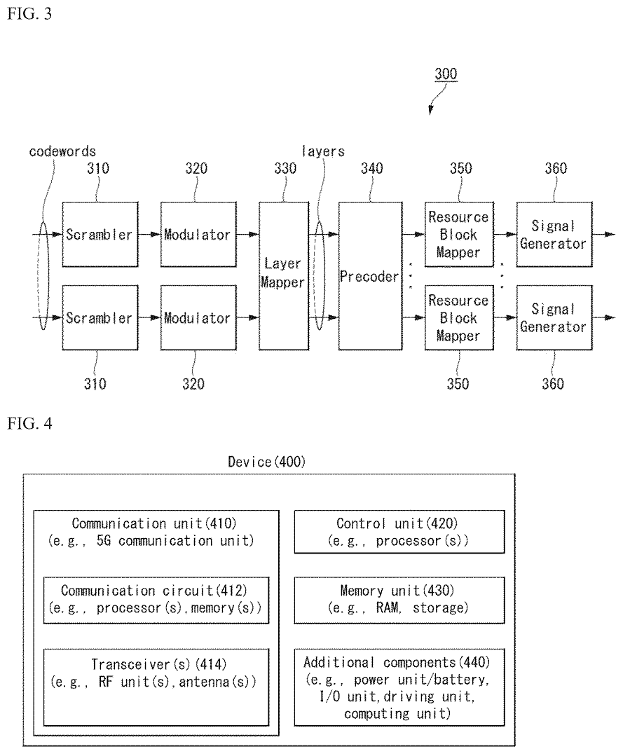

FIG. 3 is a view showing a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 310 to 350 may be implemented in the processors 202a and 202b of FIG. 2 and a block 360 may be implemented in the transceivers 206a and 206b of FIG. 2, without being limited to the above-described embodiments.

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a demodulator.

### Structure of Wireless Device Applicable to the Present Disclosure

FIG. 4 is a view showing another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 300 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

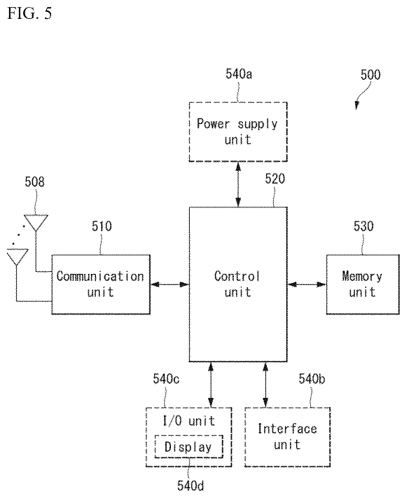

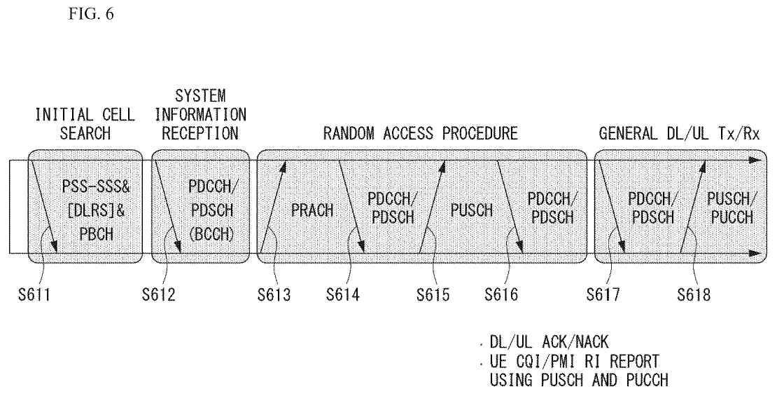

FIG. 5 is a view showing an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 400 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 400. In addition, the memory unit 530 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 6 is a view showing physical channels applicable to the present disclosure and a signal transmission method using the same.

The UE which is turned on again in a state of being turned off or has newly entered a cell performs initial cell search operation in step S611 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

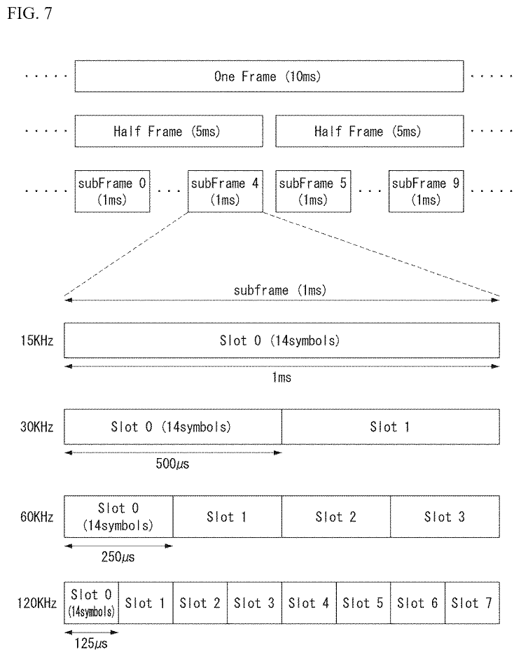

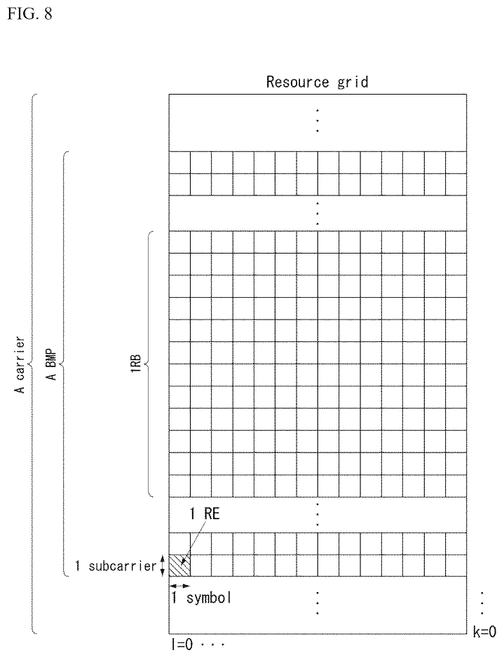

FIG. 7 is a view showing the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | ${N}_{symb}^{slot}$ | ${N}_{symb}^{frame , μ}$ | ${N}_{symb}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | ${N}_{symb}^{slot}$ | ${N}_{symb}^{frame , μ}$ | ${N}_{symb}^{subframe , μ}$ |
|---|---|---|---|
| 2 | 12 | 40 | 4 |

In Tables 1 and 2 above,

$${N}_{symb}^{slot}$$

may indicate the number of symbols in a slot,

$${N}_{slot}^{frame , μ}$$

may indicate the number of symbols in a frame, and

$${N}_{slot}^{subframe , μ}$$

may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | Subcarrier |
|---|---|---|
| designation | frequency range | Spacing |
| [symbol] | [symbol] | [symbol] |
| [symbol] | [symbol] | [symbol] |

[symbol]

indicates data missing or illegible when filed

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments.

FIG. 8 is a view showing a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P) RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is. Table 4 shows the requirements of the 6G system.

TABLE 4

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

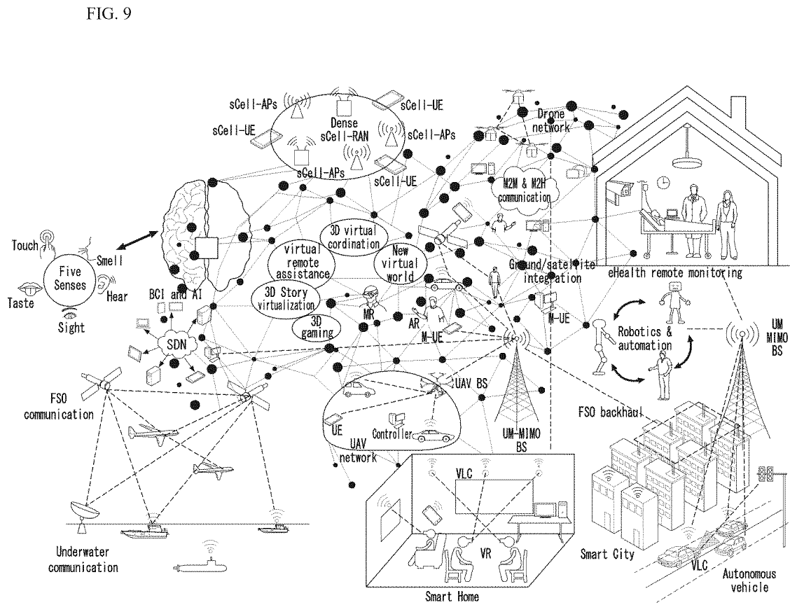

FIG. 9 is a view showing an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Quantum Communication

Quantum communication is a next-generation communication technology that can overcome the limitations of existing information and communication, such as security and ultra-high-speed computing, by applying quantum mechanical properties to an information and communication field. The quantum communication provides a means to generate, transmit, process, and store information that may not be expressed or is difficult to express in the form of 0 and 1 according to binary bit information used in existing communication technologies. In the existing communication technologies, wavelengths and amplitudes are used to transmit information between a transmitting end and a receiving end, but in quantum communication, photons, the smallest unit of light, are used to transmit information between the transmitting terminal and the receiving terminal. In particular, in the case of the quantum communication, quantum uncertainty, quantum irreversibility, and impossibility of cloning may be used for a polarization or a phase difference of photons (light), so the quantum communication has a characteristic of enabling communication in which a perfect security is guaranteed. Further, the quantum communication may enable ultra-high-speed communication using quantum entanglement under a specific condition.

In a quantum communication system through a wired or wireless communication environment, based on quantum properties, the transmitting terminal may transmit information to the receiving terminal through a quantum channel while maintaining a stability of information which the transmitting terminal wants to transmit. The quantum communication is a fundamental technology that constitutes a quantum network or quantum Internet, and is used to transmit qubit information between quantum nodes. The purpose of the quantum networks may be divided into two categories:

1) Quantum networks for computation: Networked quantum computing, or distributed quantum computing, works by connecting multiple quantum processors by transmitting qubits between the quantum processors through the quantum network.

2) Quantum networks for communication: In a realm of the quantum communication, a purpose is to transmit qubits over long distances from one quantum processor to another quantum processor.

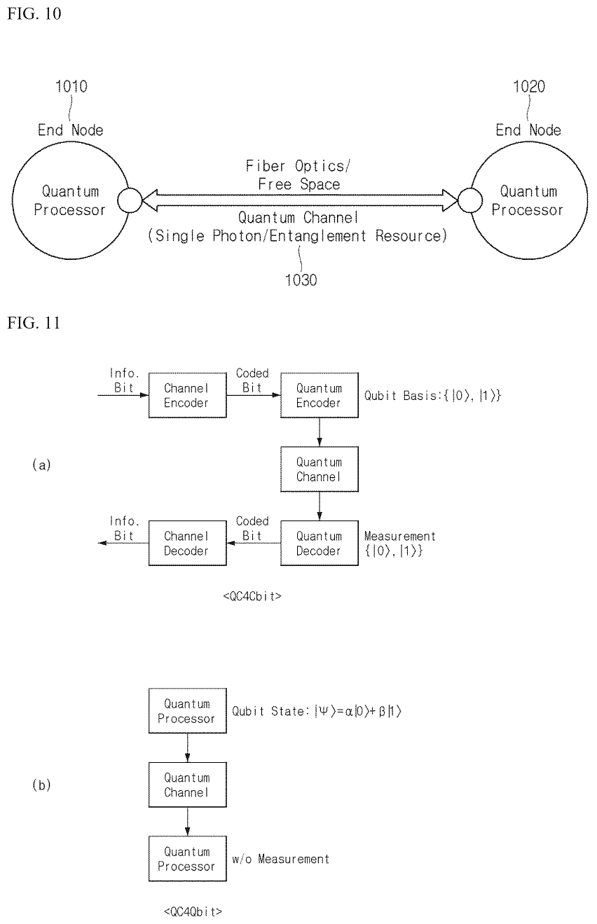

FIG. 10 is a view showing an example of a configuration of a quantum network.

Referring to FIG. 10, reference numerals 1010 and 1020 represent terminal nodes, respectively, and may operate as the transmitting terminal/the receiving terminal depending on a direction in which information is transmitted. In FIG. 10, a quantum channel 1030 may be configured as wired or wireless, and direct transmission of a single photon/multiple photons formed in the transmitting terminal or transmission of qubit information is performed through quantum teleportation while entanglement resources are shared between nodes.

FIG. 11 is a view showing examples of a configuration of a quantum communication system according to a type of information. Depending on the type of information to be transmitted, the quantum communication systems may be divided into Quantum Communication for Classical Bit (QC4Cbit) [FIG. 11(a)] and Quantum Communication for Quantum Bit (QC4Qbit) [FIG. 11(b)].

In QC4Cbit [FIG. 11(a)], classical bit information to be transmitted is converted into a qubit basis (or computation basis) by a quantum encoder, with or without applying a reliability enhancement technology such as a channel encoder. At this time, the classical bit information 0 or 1 is converted to the qubit basis 10 [symbol] or |1 [symbol] . The qubit basis, which is logical information for a quantum state, may be formed by a physical quantum basis. For example, as a promise for the quantum basis, the transmitting terminal and the receiving terminal may make a horizontal polarization and a vertical polarization correspond to the qubit bases 10 [symbol] and |1 [symbol] , respectively. The qubit basis generated in the transmitting terminal is transmitted to the receiving terminal through the quantum channel, and the quantum decoder in the receiving terminal decodes the quantum basis by performing a measurement using a quantum basis agreed upon in advance. The quantum basis measured in the receiving terminal may corresponds to the classical bit information again, and the receiving terminal obtains desired information, with or without applying a reliability enhancement technique such as a channel decoder.

QC4Qbit [FIG. 11(b)] means a scheme in which a qubit state |ψ [symbol] generated in a quantum processor of the transmitting terminal is transmitted to the receiving terminal through the quantum channel, and the receiving terminal uses the received quantum state according to its purpose. At this time, the transmitted qubit state |ψ [symbol] may be a superposition state of qubit bases and may be generally expressed as |ψ [symbol] =α|(0 [symbol] +β|1 [symbol] . At this time, the qubit bases are |0 [symbol] , and α β are probability amplitudes, and α and β have a relationship satisfying |α|²+|β|²=1. In the case of QC4Qbit, when the qubit state |ψ [symbol] received by the receiving terminal is used in the quantum processor, the qubit state |ψ [symbol] may be used for the purpose without measurement.

The qubit state may be expressed on a Bloch sphere, which is configured by a linear combination of two qubit bases (or computation bases).

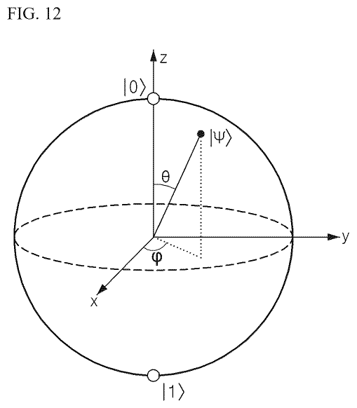

Referring to FIG. 12, it can be seen that if the condition of <|α²+|β|²=1 is satisfied, the qubit state may be expressed on the surface of the Bloch sphere. Any qubit state is a linear combination of two qubit bases, and coefficients of respective bases, α and β are complex numbers, so the Degree of Freedom (DoF) is 4. At this time, α and β always satisfy the condition of |α²+|β²=1. In the case of a Pure State Case, a value of DoF is reduced to 3. The Bloch sphere representation for the qubit state is

$$α = {e}^{j δ} cos \frac{θ}{2} , β = {e}^{j δ} {e}^{j φ} sin \frac{θ}{2} ;$$

and at this time, a global phase e^{jδ} is unnecessary, so if the global phase is removed, the Bloch sphere representation becomes

$$α = cos \frac{θ}{2} , β = {e}^{j φ} sin \frac{θ}{2} ,$$

and α becomes a real number. Therefore, the DoF of the Pure State, which always satisfies the condition of |α|²+|β|²=1 becomes 2. In the Bloch sphere, DoF=2 is formed by angles φ and θ. In the case where the condition of |α|²+|β|²=1 is not satisfied, that is, in a Mixed State Case, the qubit state may be any point inside the Bloch sphere, and a distance r from a center is added to the DoF, so that the value of the DoF becomes 3.

### DEFINITION OF TERMS

Symbols/abbreviations/terms used in the present disclosure for convenience of explanation are as follows.
QC4Cbit: Quantum Communication for Classical Bit
QC4Qbit: Quantum Communication for Quantum Bit
Qbit: Quantum Bit
Cbit: Classical Bit
QSM: Quantum State Modulation

Hereinafter, a quantization information transmission method based on qubit state quantization proposed in the present disclosure is described.

In the case of the QC4Cbit system that transmits classical bit information through quantum communication, since the classical bit information 0 or 1 is converted into the qubit basis |0 [symbol] or |1 [symbol] , one classical digital bit corresponds to one qubit. Therefore, in order to transmit multiple classical bits of information, multiple qubits must be transmitted through the quantum channel. Alternatively, the quantization information transmission method is a scheme in which the quantization information is configured as ‘Qubit’ configured as a d-dimensional Hilbert space, so d digital information may correspond to one qubit, but since the d-dimensional Hilbert space is configured as an orthogonal computation basis, d digital information is converted by using additional resources.

In the existing QC4Cbit, data is a computation basis corresponding to one digital bit, so 1-bit information may be transmitted, and in the existing QC4Qbit, data is the qubit state itself, so qubit information that may not be converted into classical bits may be transmitted.

The present disclosure proposes a scheme of transmitting multiple digital information with a single qubit based on a method in which qubit states are quantized based on a pre-agreed method and each quantized qubit state corresponds to one digital information.

In addition, in order to solve a problem that multiple digital information may not be transmitted with a single qubit through a general measurement method because a superposition state of the qubit collapses when the qubit state is measured by a computation basis in the receiving terminal, the present disclosure proposes a method for decoding target digital information by estimating the quantum state.

The present disclosure proposes a method for performing modulation based on a probability amplitude of the quantum state in a two-state quantum system using two computation bases, and for convenience of explanation, a method for performing the modulation based on the probability amplitude of the quantum state in a two-state quantum system is simply referred to as Quantum State Modulation (QSM) hereinafter.

Any quantum state is a quantum state that is quantized based on rules agreed upon in advance between the transmitting terminal and the receiving terminal, and may be expressed as |ψ [symbol] =α̅|0 [symbol] +β̅|1 [symbol] . At this time, a (α̅, β̅) pair is a constellation included in the pre-promised quantized constellation set S′.

In a QSM system, the transmitting terminal modulates the classical bit information that the transmitting terminal wants to transmit into a quantized qubit constellation in a quantum state modulator, with or without applying reliability enhancement techniques such as a channel encoder. At this time, the classical bit information is modulated by selecting from a set of QSM constellations agreed upon in advance between the transmitting terminal and the receiving terminal. The modulated quantized qubit constellation is transmitted to the receiving terminal through the quantum channel, and the quantum state demodulator of the receiving terminal performs measurement through quantum state estimation to obtain a probability amplitude (α̅, β̅) pair. The measured (α̅, β̅) pair is decoded again based on a pre-promised QSM constellation set again, with or without applying the reliability enhancement technology such as the channel decoder, to obtain the classical bit information.

The process of modulating the classical bit information based on the QSM constellation set in the transmitting terminal described above, the process of transmitting the modulated quantum-modulated qubit constellation onto the quantum channel, etc., are described in detail below.

### Quantum State Constellation Design

A complete set of quantum state constellations used in QSM is called a Quantized Constellation Set s. At this time, the complete set of quantum state constellations may be expressed as the ith quantized constellation qubit included in the quantized constellation set S′, Qᵢ=(α̅₁̅, β̅₁̅). The quantized constellation set S′ of the QSM described in the present disclosure assumes uniform quantization on a sphere surface represented by the Bloch sphere in a two-dimensional Hilbert space.

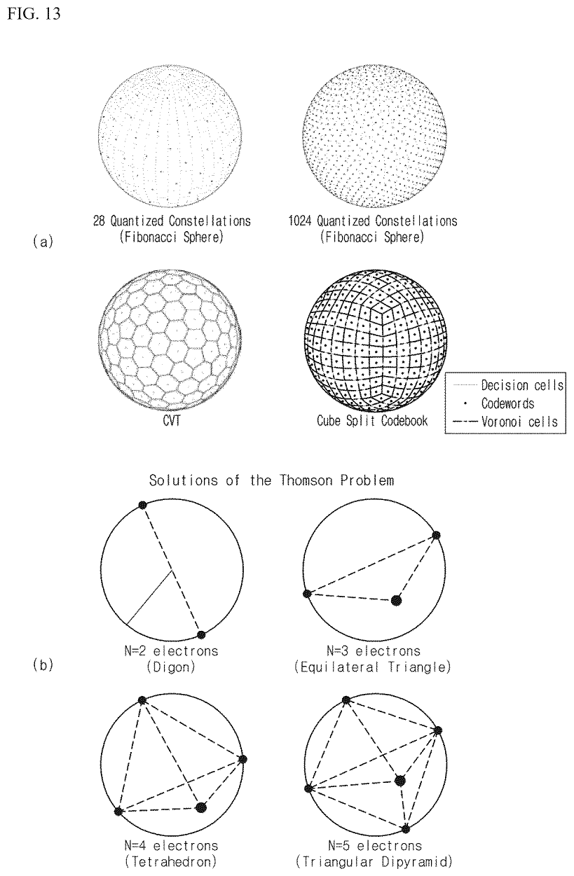

FIG. 13 is a view showing an example of uniform quantization methods.

Referring to FIG. 13(a), the uniform quantization method may be performed through optimal quantization for a surface of a unit sphere based on algorithms such as Spherical Fibonacci Lattice, Centroidal Voronoi Tessellation (CVT), Cube Split Codebook, and Lloyd Max Quantizer.

Further, referring to FIG. 13(b), the uniform quantization method may also be performed through optimal quantization for the surface of the unit sphere based on a Mathematical Approach such as Sphere Packing Problem, Tammes Problem, Thomson Problem, etc.

### Optimal Euclidean Distance Based OSM Constellation

The quantized constellation set S′ of the QSM proposed in the present disclosure includes quantized qubit constellations obtained by applying the optimal quantization on the surface of the unit sphere to the Bloch sphere.

The quantized constellation set S of the QSM is obtained by deriving an optimal quantization point for the surface of the unit sphere, and may be organized as a general problem as shown in Equation 1 below.

$$max \{ {min}_{{c}_{i} , {c}_{j} ∈ {S}^{2}} \vert {c}_{i} - {c}_{j} \vert \} , for i \neq j and i , j = 1 , … , N \qquad [ Equation 1 ]$$

In the above equation, S³ represents a set of all coordinates on the surface of the unit sphere formed by a three-dimensional orthogonal coordinate system, and cᵢ is a coordinate cᵢ=(xᵢ, yᵢ, zᵢ) expressed in an orthogonal coordinate system. Therefore, the problem is to maximize a minimum distance between N coordinates on the surface of the unit sphere. The problem may be derived mathematically for a three-dimensional sphere and may be defined up to N=4, . . . , 130. In addition, when the general problem is re-expressed in spherical coordinates, the general problem may be organized as shown in Equation 2 below.

$$max \{ {min}_{\text{?}} \sqrt{2 - 2 ( sin {θ}_{i} sin {θ}_{j} cos ( {φ}_{i} - {φ}_{j} ) + cos {θ}_{i} cos {θ}_{j} )} \} , \qquad [ Equation 2 ]$$

$$for i \neq j and i , j = 1 , … , N$$

$$\text{?} \text{indicates text missing or illegible when filed}$$

Assuming that the problem is derived mathematically, the constellation for the QSM may be defined as follows.

To represent one point on the surface of the Bloch Sphere expressing the quantum state as a constellation, when a point of the ith constellation is called Qᵢ, Qᵢ is expressed as a (φᵢ, θᵢ) pair in the spherical coordinates. At this time, the quantized qubit state represented by the ith constellation point may be represented as |ψᵢ [symbol] =α̅ᵢ̅|0 [symbol] +β̅ᵢ̅|1 [symbol] ), where

$${\overline{α}}_{i} = cos \frac{{θ}_{i}}{2} , {\overline{β}}_{i} = {e}^{j {φ}_{i}} sin \frac{{θ}_{i}}{2} .$$

In the present disclosure, when a size of the quantized constellation set S′ is |S|=N, the quantum state modulation may be referred to as N-QSM.

### [N-QSM]

When the size of the quantized constellation set S′ is |S|=N, the constellation may be defined as follows.

### Set of Constellation:

$$S = \{ {Q}_{i} \} = \{ ( {\overline{α}}_{i} , {\overline{β}}_{i} ) \} for i = 1 , … , N$$

### ith Constellation:

$$( \text{?} , \text{?} ) ∈ S where ( \text{?} = cos \frac{{θ}_{i}}{2} , \text{?} = \text{?} sin \frac{{θ}_{i}}{2} ) for i = 1 , ... , N$$

$$\text{?} \text{indicates text missing or illegible when filed}$$

Where (φᵢ, θᵢ) represents the ith quantized qubit constellation obtained through the optimal quantization on the surface of the Bloch sphere.
# of Constellation: N=|S|
Length of Bit Mapping Sequence: B=log₂(N)
Condition: |α̅ᵢ̅|²+|β̅ᵢ̅|²=1 for i=1, . . . , N

Where each of the N constellation points is an optimal Euclidean distances (φᵢ, θᵢ) pair derived by the general problem.

Further, the number of quantized qubit states, N may be limited and promised to 2^{B} from the viewpoint of a modulation, and defined by the number of bits, B.

### [2-QSM (Optimal Optimal Euclidean Case)]

In the N-QSM, when N=2 (B=1), the constellation may be defined by the computation basis in the same manner as the existing QDC system, and the constellation set may be defined as follows.
Set of Constellation: S={Q₁, Q₂}={(α̅, β̅), (α̅, β̅)}
ith Constellation:

$$( {\overline{α}}_{i} , {\overline{β}}_{i} ) ∈ S where ( {\overline{α}}_{i} = cos \frac{{θ}_{i}}{2} , {\overline{β}}_{i} = {e}^{j {φ}_{i}} sin \frac{{θ}_{i}}{2} ) for i = 1 , 2$$

Where (φᵢ, θᵢ) represents the ith quantized qubit constellation obtained through the optimal quantization on the surface of the Bloch sphere.

# of Constellation: N=|S|=2

Where each of the two constellation points is an optimal Euclidean distances (φᵢ, θᵢ) pair derived by the general problem.
Length of Bit Mapping Sequence: B=log₂(N)=1
Condition: |α̅ᵢ̅²+|β̅ᵢ̅|²=1 for i=1, 2

$$Set of Bit Sequence = \{ 0 , 1 \}$$

Bit Mapping: {Q₁, Q₂}→(0, 1′)

The 2-QSM mapping table obtained based on the optimal quantization may be defined/set as shown in Table 5 below.

TABLE 5

| Constellation Index [symbol] | Bit Mapping | [symbol] | [symbol] |
|---|---|---|---|
| [symbol] | [symbol] | [symbol] | [symbol] |
| [symbol] | [symbol] | [symbol] | [symbol] |

[symbol]

indicates data missing or illegible when filed

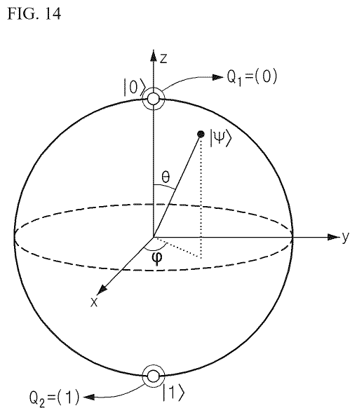

FIG. 14 is a view showing an example of 2-QSM constellations plotted on the surface of the Bloch sphere. Referring to FIG. 14, for the 2-QSM, the Bloch sphere surface may be quantized into two regions.

### [4-QSM (Optimal Euclidean Distance Case)]

In the N-QSM, a mapping method for establishing the optimal Euclidean distance between constellations when N=4 may be defined as follows.
Set of Constellation: S={Q₁, Q₂, Q₃, Q₄}={(α̅₁̅, β̅₁̅), (α̅₂̅, β̅₂̅), (α̅₃̅, β̅₃̅), (α̅₄̅, β̅₄̅)}
ith Constellation:

$$( {\overline{α}}_{i} , {\overline{β}}_{i} ) ∈ S where ( {\overline{α}}_{i} = cos \frac{{θ}_{i}}{2} , {\overline{β}}_{i} = {e}^{j {φ}_{i}} sin \frac{{θ}_{i}}{2} ) for i = 1 , … , 4$$

Where (φᵢ, θᵢ) represents the ith quantized qubit constellation obtained through the optimal quantization on the surface of the Bloch sphere.

# of Constellation: N=|S|=4

Where each of the four constellation points is an optimal Euclidean distances (φᵢ, θᵢ) pair derived by the general problem.

Length of Bit Mapping Sequence:

$$B = {log}_{2} ( N ) = 2$$

Condition: |α̅ᵢ̅|²+|β̅ᵢ̅|²=1 for i=1, . . . , 4

$$Set of Bit Sequence = \{ 00 , 01 , 10 , 11 \}$$

Bit Mapping: {Q₁, Q₂, Q₃, Q₄}→(00, 01, 10, 11)

The 4-QSM mapping table obtained based on the optimal quantization may be defined/set as shown in Table 6 below.

TABLE 6

| Constellation Index i | Bit Mapping | ( [symbol] ) | ( [symbol] ) |
|---|---|---|---|
| 1 | 00 | ( [symbol] ) | ( [symbol] ) |
| 2 | 01 | $( \text{?} )$ | $( \text{?} )$ |
| 3 | 10 | $( \text{?} )$ | $( \sqrt{\text{?}} - \sqrt{\text{?}} + \sqrt{\text{?}} \text{?} )$ |
| 4 | 11 | $( \text{?} )$ | $( \sqrt{\frac{1}{\text{?}}} - \sqrt{\frac{1}{\text{?}}} - \sqrt{\frac{1}{\text{?}}} \text{?} )$ |

[symbol]

indicates data missing or illegible when filed

FIG. 15 is a view showing an example of 4-QSM constellations plotted on the surface of the Bloch sphere. Referring to FIG. 15, for the 4-QSM, the Bloch sphere surface may be quantized into four regions.
[8-QSM (Optimal Euclidean Distance Case)]

In the N-QSM, a mapping method for establishing the optimal Euclidean distance between constellations when N=8 may be defined as follows.

Set of Constellation: S={Q₁, . . . , Q₀}={(α̅₁̅, β̅₁̅), . . . , (α̅₀̅, β̅₀̅)}

ith Constellation:

$$( {\overline{α}}_{i} , {\overline{β}}_{i} ) ∈ S where ( {\overline{α}}_{i} = cos \frac{{θ}_{i}}{2} , {\overline{β}}_{i} = {e}^{j {φ}_{i}} sin \frac{{θ}_{i}}{2} ) for i = 1 , … , 8$$

Where (φᵢ, θᵢ) represents the ith quantized qubit constellation obtained through the optimal quantization on the surface of the Bloch sphere.

# of Constellation: N=|S|=8

Where each of the eight constellation points is an optimal Euclidean distances (φᵢ, θᵢ) pair derived by the general problem.

Length of Bit Mapping Sequence:

$$B = {log}_{2} ( N ) = 3$$

Condition: |α̅ᵢ̅|²+|β̅ᵢ̅|²=1 for i=1, . . . , 8

$$Set of Bit Sequence = \{ 000 , ... , 111 \}$$

### Bit Mapping:

The 8-QSM mapping table obtained based on the optimal quantization may be defined/set as shown in Table 7 below.

TABLE 7

| Constellation Index i | Bit Mapping | ( [symbol] ) | ( [symbol] ) |
|---|---|---|---|
| 1 | 000 | $( \text{?} )$ | $( \text{?} )$ |
| 2 | [symbol] | $( \text{?} )$ | $( \text{?} )$ |
| 3 | [symbol] | $( \text{?} )$ | $( \text{?} )$ |
| 4 5 | [symbol] [symbol] | $( \text{?} ) \\ ( \text{?} )$ | $( \text{?} ) \\ ( \text{?} )$ |
| 6 | [symbol] | $( \text{?} )$ | $( \text{?} )$ |
| 7 | [symbol] | $( \text{?} )$ | $( \text{?} )$ |
| 8 | [symbol] | $( \text{?} )$ | $( \sqrt{\text{?}} - \sqrt{\text{?}} - \sqrt{\text{?}} \text{?} )$ |

[symbol]

indicates data missing or illegible when filed

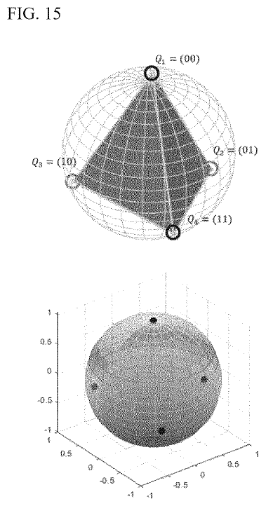

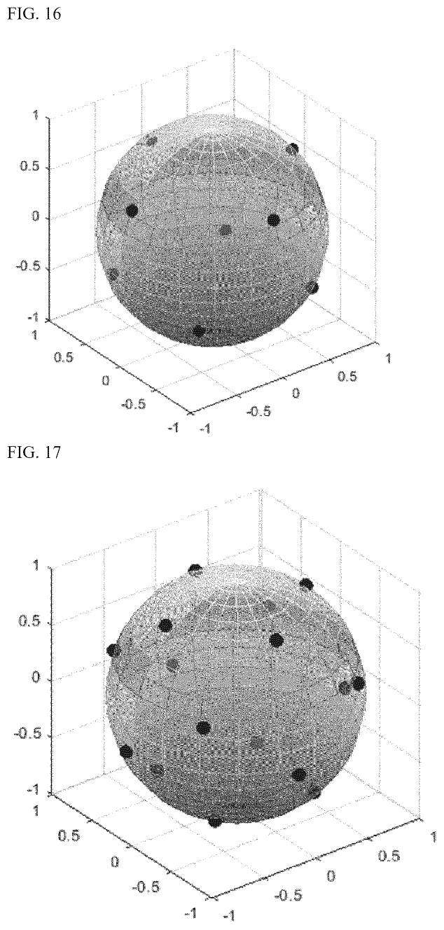

FIG. 16 is a view showing an example of 8-QSM constellations plotted on the surface of the Bloch sphere. Referring to FIG. 16, for the 8-QSM, the Bloch sphere surface may be quantized into eight regions.
[16-QSM (Optimal Euclidean Distance Case)]

In the N-QSM, a mapping method for establishing the optimal Euclidean distance between constellations when N=16 may be defined as follows.

Set of Constellation: S={Q₁, . . . , Q₁₆}={(α̅₁̅, β̅₁̅), . . . , (α̅₁̅₆̅, β̅₁̅₆̅)}

ith Constellation:

$$( {\overline{α}}_{i} , {\overline{β}}_{i} ) ∈ S where ( {\overline{α}}_{i} = cos \frac{{θ}_{i}}{2} , {\overline{β}}_{i} = {e}^{l {φ}_{i}} sin \frac{{θ}_{i}}{2} ) for i = 1 , … , 16$$

Where (φᵢ, θᵢ) represents the ith quantized qubit constellation obtained through the optimal quantization on the surface of the Bloch sphere.

# of Constellation: N=|S|=16

Where each of the sixteen constellation points is an optimal Euclidean distances (φᵢ, θᵢ) pair derived by the general problem.
Length of Bit Mapping Sequence: B=log₂(N)=4
Condition: |α̅ᵢ̅|²+|β̅ᵢ̅|²=1 for i=1, . . . 16

$$Set of Bit Sequence = \{ 000 , ... , 1111 \}$$

Bit Mapping: (Q₁, . . . , Q₁₀→{000, . . . , 1111}

The 16-QSM mapping table obtained based on the optimal quantization may be defined/set as shown in Table 8 below. In Table 8 below, when xi, yi, and zi are coordinates of an orthogonal coordinate system of the mathematically obtained optimal constellation point are converted into spherical coordinates and then converted into the probability amplitude, xi, yi, and zi may be expressed as 2-QSM, 4-QSM, and 8-QSM above.

TABLE 8

| Constellation | Bit | | | |
|---|---|---|---|---|
| index [symbol] | Napping | [symbol] | [symbol] | [symbol] |
| 1 | 0000 | 0.1266 | 0.9636 | −0.2357 |
| 2 | 0001 | −0. [symbol] | 0.7709 | 0.2357 |
| 3 | 0010 | 0.0611 | 0. [symbol] 174 | 0.7825 |
| 4 | 0011 | −0. [symbol] 792 | 0. [symbol] 939 | −0.7825 |
| 5 | 0100 | −0.9636 | 0.1266 | −0.2357 |
| 6 | 0101 | −0.7709 | −0.591 [symbol] | 0. [symbol] 7 |
| 7 | 0110 | −0.617 [symbol] | 0.0811 | 0.7825 |
| 8 | 0111 | −0.4939 | −0.3792 | −0.7025 |
| 9 | 1000 | −0.1266 | −0.9636 | −0.2357 |
| 10 | 1001 | 0.5918 | −0.7709 | 0.2357 |
| 11 | 1010 | −0.0811 | −0.6174 | 0.7625 |
| 12 | 1011 | 0.3792 | −0.4939 | −0.7825 |
| 13 | 1100 | 0.9636 | −0.1266 | −0.23 [symbol] 7 |
| 14 | 1101 | 0.7709 | 0.5918 | 0.2357 |
| 15 | 1110 | 0.6174 | −0.0811 | 0.7 [symbol] 5 |
| 16 | 1111 | 0.4939 | 0.3792 | −0.78 [symbol] 5 |

[symbol]

indicates data missing or illegible when filed

FIG. 17 is a view showing an example of 16-QSM constellations plotted on the surface of the Bloch sphere. Referring to FIG. 17, for the 16-QSM, the Bloch sphere surface may be quantized into sixteen regions.

### [64-QSM (Optimal Euclidean Distance Case)]

In the N-QSM, a mapping method for establishing the optimal Euclidean distance between constellations when N=64 may be defined as follows.

Set of Constellation: S={Q₁, . . . , Q₆₄}={(α̅₁̅, β̅₁̅), . . . , (α̅₆̅₄̅, β̅₆̅₄̅)}

ith Constellation:

$$( {\overline{α}}_{i} , {\overline{β}}_{i} ) ∈ S where ( {\overline{α}}_{i} = cos \frac{{θ}_{i}}{2} , {\overline{β}}_{i} = {e}^{j {φ}_{i}} sin \frac{{θ}_{i}}{2} ) for i = 1 , … , 64$$

Where (φᵢ, θᵢ) represents the ith quantized qubit constellation obtained through the optimal quantization on the surface of the Bloch sphere.

# of Constellation: N=|S|=64

Where each of the sixty four constellation points is an optimal Euclidean distances (φᵢ, θᵢ) pair derived by the general problem.

### Length of Bit Mapping Sequence:

$$B = {log}_{2} ( N ) = 6$$

Condition: (Q₁, . . . , Q₆₄)→{000, . . . , 111111}

$$Set of Bit Sequence = \{ 000 , ... , 111111 \}$$

Bit Mapping: {Q₁, . . . , Q₆₄)→(000, . . . , 111111}

The 64-QSM mapping table obtained based on the optimal quantization may be defined/set as shown in Table 9 below. In Table 9 below, when xi, yi, and zi are the coordinates of the orthogonal coordinate system of the mathematically obtained optimal constellation point are converted into the spherical coordinates and then converted into the probability amplitude, xi, yi, and zi may be expressed as 2-QSM, 4-QSM, and 8-QSM above.

TABLE 9

| Constellation | [symbol] | | | |
|---|---|---|---|---|
| Index [symbol] | Mapping | [symbol] | [symbol] | [symbol] |
| 1 | 000000 | −0.4725 | 0.2632 | −0. [symbol] 411 |
| 2 | 000001 | − [symbol] | 0.5125 | −0.3274 |
| 3 | 000010 | − [symbol] | 0.99 [symbol] 7 | −0.0716 |
| 4 | 000011 | 0.0295 | −0.2588 | 0.9655 |
| 5 | 000100 | 0.384 [symbol] | −0.5 [symbol] | −0. [symbol] |
| 6 | 000101 | 0. [symbol] | 0.7020 | 0.1600 |
| 7 | 000110 | −0.7054 | −0.6471 | −0.2 [symbol] 3 |
| 8 | 000111 | −0.6612 | −0.4940 | 0.564 [symbol] |
| 9 | 001000 | 0.3130 | −0.1265 | −0.0413 |
| 10 | 001001 | −0.2127 | 0. [symbol] 063 | 0.7662 |
| 11 | 001010 | −0.3207 | −0.88 [symbol] 1 | −0.3 [symbol] |
| 12 | 001011 | −0.2652 | −0.5639 | 0.767 [symbol] |
| 13 | 001100 | −0.3943 | 0.8 [symbol] 59 | 0.2444 |
| 14 | 001101 | 0. [symbol] | 0.0337 | −0. [symbol] 689 |
| 15 | 001110 | −0.9611 | −0.1425 | 0.2368 |
| 16 | 001111 | −0. [symbol] 059 | 0.2641 | 0.8212 |
| 17 | 010000 | −0.3926 | −0.59 [symbol] 2 | −0.6985 |
| 18 | 010001 | −0.41 [symbol] | −0.1841 | −0. [symbol] 915 |
| 19 | 010010 | 0.6234 | 0.3416 | 0.7034 |
| 20 | 010011 | 0.2237 | −0.94 [symbol] 1 | −0.3537 |
| 21 | 010100 | −0.4974 | 0.8452 | −0.1958 |
| 22 | 010101 | 0. [symbol] 524 | −0.6742 | 0.4902 |
| 23 | 010110 | −0.0758 | 0.1021 | −0. [symbol] 919 |
| 24 | 010111 | −0.7 [symbol] 30 | 0.6373 | 0.1079 |
| 25 | 011000 | −0.4108 | −0.1735 | 0.8 [symbol] 51 |
| 26 | 011001 | −0.4511 | 0. [symbol] 500 | −0.6040 |
| 27 | 011010 | 0.8998 | − [symbol] .4073 | −0.1561 |
| 28 | 011011 | 0.6626 | 0.08 [symbol] | −0.7441 |
| 29 | 011109 | 0.5260 | −0.3293 | 0.7841 |
| 30 | 011101 | 0.6729 | −0.7375 | 0.0 [symbol] 72 |
| 31 | 011110 | 0.1863 | 0.6289 | 0.7548 |
| 32 | 011111 | −0.0285 | −0.4234 | −0.9055 |
| 33 | 100000 | −0.8148 | −0.5618 | 0.1429 |
| 34 | 100001 | −0.0940 | 0.5303 | 0. [symbol] 425 |
| 35 | 100010 | −0.7673 | − [symbol] .0589 | 0.63 [symbol] 5 |
| 36 | 100011 | 0.0240 | −0.77 [symbol] 3 | −0.6274 |
| 37 | 100100 | −0.8852 | 0.2855 | 0. [symbol] 674 |
| 38 | 100101 | 0.8161 | −0. [symbol] | 0.5758 |
| 39 | 100110 | −0.0021 | 0.0012 | 0.4728 |
| 40 | 100111 | 0.3074 | 0.3249 | −0.8944 |
| 41 | 101000 | 0.5157 | 0.8225 | −0.2399 |
| 42 | 101001 | −0.0 [symbol] | 0.1792 | 0.9798 |
| 43 | 101010 | −0.9421 | −0.2700 | −0. [symbol] |
| 44 | 101011 | 0.9967 | −0.0292 | 0.0755 |
| 45 | 101100 | [symbol] .3318 | 0.6970 | −0.6356 |
| 46 | 101101 | −0.9809 | 0.1711 | −0.0922 |
| 47 | 101110 | −0.0741 | −0. [symbol] 758 | 0.4769 |
| 48 | 101111 | [symbol] | 0.4 [symbol] 1 | 0.84 [symbol] 4 |
| 49 | 110000 | 0.7 [symbol] 05 | 0.4762 | −0.5180 |
| 50 | 110001 | −0.0711 | 0.8 [symbol] 01 | −0.50 [symbol] |
| 51 | 110010 | 0.2948 | −0.9303 | 0.2181 |
| 52 | 110011 | 0.7486 | −0. [symbol] | −0. [symbol] 65 |
| 53 | 110100 | −0.6002 | 0.5992 | 0.5299 |
| 54 | 110101 | −0.8112 | 0.1294 | −0.5702 |
| 55 | 110110 | 0.5896 | −0.70 [symbol] 4 | −0.1880 |
| 56 | 110111 | −0.7349 | −0.3170 | −0.5 [symbol] |
| 57 | 111000 | −0.4767 | −0.8362 | 0.2711 |
| 58 | 111001 | 0.3077 | 0. [symbol] 401 | 0. [symbol] 4 |
| 59 | 111010 | 0. [symbol] 057 | 0.40 [symbol] | −0. [symbol] 39 |
| 60 | 111011 | 0.45 [symbol] | 0.7304 | 0.52 [symbol] 4 |
| 61 | 111100 | 0.3501 | 0.0611 | 0.9347 |
| 62 | 111101 | −0.1183 | −0.9922 | 0.0404 |
| 63 | 111110 | 0.8657 | −0.4034 | 0.2965 |
| 64 | 111111 | 0.8844 | 0.3278 | 0. [symbol] |

[symbol]

indicates data missing or illegible when filed

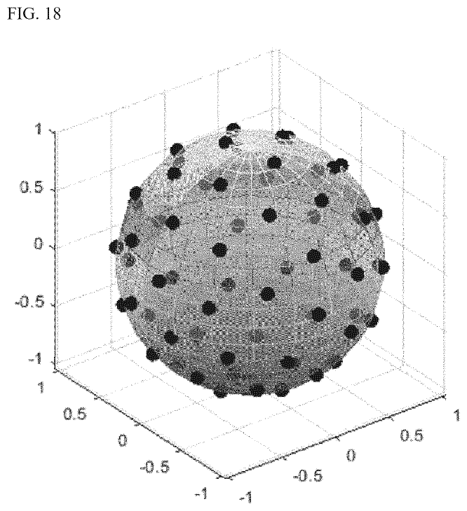

FIG. 18 is a view showing an example of 64-QSM constellations plotted on the surface of the Bloch sphere. Referring to FIG. 18, for the 64-QSM, the Bloch sphere surface may be quantized into sixty four regions.

Through the same method as the method described above, the optimal constellation may be obtained for all Ns, and an N-QSM mapping table may be defined in advance between the transmitting terminal and the receiving terminal. The N-QSM mapping table defined in advance is promised between the transmitting terminal and the receiving terminal. In the N-QSM mapping table defined in advance, an N value for modulation in the transmitting terminal and the receiving terminal may be set, and a step of exchanging information for the N value between the transmitting terminal and the receiving terminal may be performed. More specifically, the transmitting terminal may transmit the information for the value of N to the receiving terminal. Alternatively, the receiving terminal may transmit the information for the value of N to the transmitting terminal.

Afterwards, the transmitting terminal maps the information bits to the quantized qubit constellation based on the set N value, and transmits the qubits generated based on the mapped constellation to the receiving terminal.

Next, the receiving terminal measures the qubit state through quantum state measurement, and decodes the information bits by demapping the constellation based on the set N value.

Additionally, when the transmitting terminal is a terminal and the receiving is a base station, the information for the value of the N may be exchanged between the transmitting terminal and the receiving terminal after a connection between the transmitting terminal and the receiving terminal is formed. Here, the connection may be a radio resource control (RRC) connection. At this time, the information for the value of the N may be transmitted as included in the system information transmitted by the base station to the terminal. Further, the information for the value of the N may be transmitted from the base station to the terminal via an RRC signaling. Here, in order to form the RRC connection, the transmitting terminal may receive a signal for synchronization with the receiving terminal from the receiving terminal. Here, the signal for the synchronization may be a primary synchronization signal (PSS) and/or system information from the receiving terminal. Here, the system information may be information included in a Master Information Block (MIB). Thereafter, the transmitting terminal may perform a random access procedure with the receiving terminal to establish an initial connection to the receiving terminal. Here, the RRC connection between the transmitting terminal and the receiving terminal may be formed based on the random access procedure. Thereafter, the transmitting terminal may receive configuration information from the receiving terminal, and the configuration information may include the value for the N. It goes without saying that the described contents may also be applied when the transmitting terminal is the base station and the receiving terminal is the terminal.

Simple Algorithm based QSM Constellation Design

The quantized constellation set S of the QSM proposed in the present disclosure includes quantized qubit constellations obtained by applying the optimal quantization on the surface of the unit sphere to the Bloch sphere. In this method, the general problem of establishing the optimized Euclidean distance between the constellations may be defined in the same manner as in Equation 1 above. When a solution to the general problem is mathematically derived, the transmitting terminal and the receiving terminal must store a large number of significant constant values of the obtained QSM constellation, which may increase a memory burden of the transmitting terminal and the receiving terminal for storing the QSM table for the promise between the transmitting terminal and the receiving terminal. Therefore, this method proposes a QSM constellation design method using an intuitive and simple algorithm. The QSM constellation design method proposed by this method may not guarantee the optimized Euclidean distance, but may minimize the amount of information required to store constellations.
[4-QSM (Optimal Gray Mapping Case)]

From the viewpoint of Gray Mapping for the constellation when N=4, optimal mapping may be defined/set as follows. In particular, the constellation in this method is obtained by considering a Gray code that maximizes a Hamming distance, such as QPSK or 4QAM, and may be obtained by simply dividing a phase for any circle on a sphere surface.

Set of Constellation: S={Q₁, Q₂, Q₃, Q₄}={(α̅₁̅, β̅₁̅), (α̅₂̅, β̅₂̅), (α̅₃̅, β̅₃̅), (α̅₄̅, β̅₄̅)}

ith Constellation:

$$( \overline{α} \text{?} , \overline{β} \text{?} ) ∈ S where ( \overline{α} \text{?} = cos \text{?} , \overline{β} \text{?} = e \text{?} sin \text{?} ) for l = 1 , … , 4$$

$$\text{?} \text{indicates text missing or illegible when filed}$$

Where (φᵢ, θᵢ) represents the ith quantized qubit constellation obtained through the optimal quantization on the surface of the Bloch sphere.

# of Constellation: N=|S|=4

Length of Bit Mapping Sequence:

$$B = {log}_{2} ( N ) = 2$$

Condition: |α̅ᵢ̅|+|β̅ᵢ̅|²=1 for i=1 . . . , 4

$$Set of Bit Sequence = \{ 00 , 01 , 10 , 11 \}$$

Bit Mapping: {Q₁, Q₂, Q₃, Q₄}→00, 01, 10, 11)

The 4-QSM mapping table obtained based on the optimal quantization may be defined/set as shown in Table 10 below.

TABLE 10

| Constellation Index i | Bit Mapping | ( [symbol] ) | ( [symbol] ) |
|---|---|---|---|
| 1 | 00 | (0, 0) | (1, 0) |
| 2 | 01 | $( \frac{π}{2} , \frac{π}{2} )$ | $( \sqrt{\frac{1}{2}} \text{?} \sqrt{\frac{1}{2}} \text{?} )$ |
| 3 | 10 | $( \frac{\text{?} π}{2} , \frac{π}{2} )$ | $( \sqrt{\frac{1}{2}} \text{?} \sqrt{\frac{1}{2}} \text{?} )$ |
| 4 | 11 | (0, π) | (0, 1) |

[symbol]

indicates data missing or illegible when filed

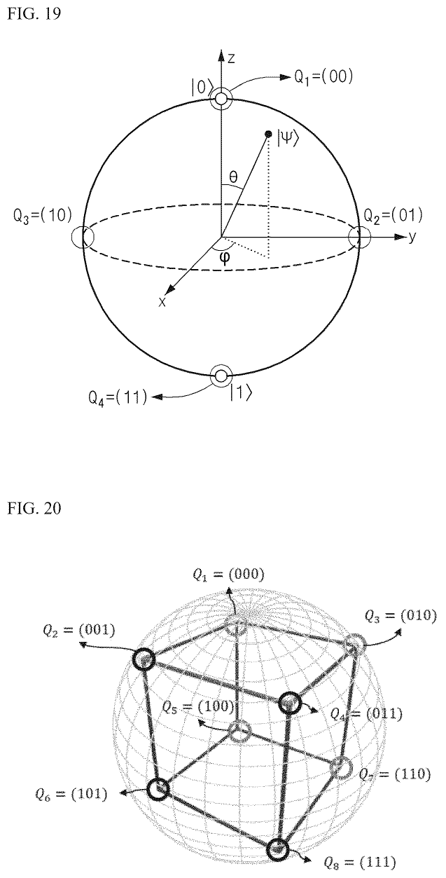

FIG. 19 is a view showing an example of 4-QSM constellations plotted on the surface of the Bloch sphere. Referring to FIG. 19, for the 4-QSM, the Bloch sphere surface may be quantized into four regions.

Further, the constellation considering the Gray Code that maximizes the Hamming Distance for N=8, 16, and 64 may be obtained only by dividing an inclination phase θ and an azimuth phase φ.

The division of the azimuth phase is according to Equation 3 below.

$$\overline{{φ}_{n}} = \text{?} where = 1 , … , L , L = \{ \begin{matrix}4 for N = 8 \\ 4 for N = 16 \\ 8 for N = 64\end{matrix} \qquad [ Equation 3 ]$$

$$\overline{{θ}_{m}} = \text{?} where = 1 , … , M , M = \{ \begin{matrix}2 for N = 8 \\ 4 for N = 16 \\ 8 for N = 64\end{matrix} \qquad [ Equation 4 ]$$

$$\text{?} \text{indicates text missing or illegible when filed}$$

From the viewpoint of Gray Mapping for the constellation when N=8, the optimal mapping may be defined/set as follows. Here, considering the Gray Mapping, the divided phases may be arranged as in Equations 5 and 6 below.

$$φ = [ {φ}_{1} , … , {φ}_{0} ] = [ \overline{{φ}_{1}} , \overline{{φ}_{2}} , \overline{{φ}_{4}} , \overline{{φ}_{3}} , \overline{{φ}_{1}} , \overline{{φ}_{2}} , \overline{{φ}_{4}} , \overline{{φ}_{3}} ] \qquad [ Equation 5 ]$$

$$θ = [ {θ}_{1} , … , {θ}_{0} ] = [ \overline{{θ}_{1}} , \overline{{θ}_{1}} , \overline{{θ}_{1}} , \overline{{θ}_{1}} , \overline{{θ}_{2}} , \overline{{θ}_{2}} , \overline{{θ}_{2}} , \overline{{θ}_{2}} ] \qquad [ Equation 6 ]$$

Set of Constellation: S={Q₁, . . . , Q₈}={(α̅₁̅, β̅₁̅), . . . , (α̅₈̅, β̅₈̅)}

ith Constellation:

$$( \text{?} , \text{?} ) ∈ S where ( \text{?} = cos \frac{{θ}_{i}}{2} , \text{?} = \text{?} sin \frac{{θ}_{i}}{2} ) for i = 1 , ... , 8$$

$$\text{?} \text{indicates text missing or illegible when filed}$$

Where (φᵢ, θᵢ) represents the ith quantized qubit constellation obtained through the optimal quantization on the surface of the Bloch sphere.

# of Constellation: N=|S|=8

Length of Bit Mapping Sequence: B=log₂(N)=3

Condition: |αᵢ|²+|β̅ᵢ̅|=1 for i=1, . . . , 8

$$Set of Bit Sequence = \{ 000 , ... , 111 \}$$

Bit Mapping: (Q₁, Q₈)→{000, . . . , 111}

The 8-QSM mapping table obtained based on the optimal quantization may be defined/set as shown in Table 11 below.

TABLE 11

| Constellation Index i | Bit Mapping | ( [symbol] ) | ( [symbol] ) |
|---|---|---|---|
| 1 | 000 | $( \text{?} \frac{π}{3} )$ | $( \sqrt{\frac{3}{4}} \text{?} \sqrt{\frac{1}{4}} \text{?} )$ |
| 2 | 001 | $( \frac{π}{2} , \frac{π}{3} )$ | $( \sqrt{\frac{3}{4}} \text{?} \sqrt{\frac{1}{4}} \text{?} )$ |
| 3 | 010 | $( \frac{3 π}{2} , \frac{π}{3} )$ | $( \sqrt{\frac{3}{4}} \text{?} \sqrt{\frac{\text{?}}{\text{?}}} \text{?} )$ |
| 4 | 011 | $( \text{?} \frac{\text{?}}{3} )$ | $( \sqrt{\frac{3}{4}} \text{?} \sqrt{\frac{\text{?}}{4}} )$ |
| 5 | 100 | $( \text{?} \frac{\text{?}}{3} )$ | $( \sqrt{\frac{\text{?}}{4}} \text{?} \sqrt{\frac{\text{?}}{4}} )$ |
| 6 | 101 | $( \frac{\text{?}}{2} \text{?} \frac{\text{?}}{3} )$ | $( \sqrt{\frac{\text{?}}{4}} \text{?} \sqrt{\frac{\text{?}}{4}} \text{?} )$ |
| 7 | 110 | $( \frac{\text{?}}{2} \text{?} \frac{\text{?}}{3} )$ | $( \sqrt{\frac{\text{?}}{\text{?}}} \text{?} \sqrt{\frac{\text{?}}{\text{?}}} \text{?} )$ |
| 8 | 111 | $( \text{?} \frac{\text{?}}{3} )$ | $( \sqrt{\frac{\text{?}}{4}} \text{?} \sqrt{\frac{3}{4}} )$ |

[symbol]

indicates data missing or illegible when filed

FIG. 20 is a view showing an example of 8-QSM constellations plotted on the surface of the Bloch sphere. Referring to FIG. 20, for the 8-QSM, the Bloch sphere surface may be quantized into eight regions.

### [16-QSM]

From the viewpoint of Gray Mapping for the constellation when N=16, the optimal mapping may be defined/set as follows. Here, considering the Gray Mapping, the divided phases may be arranged as in Equations 7 and 8 below.

$$φ = [ {φ}_{1} , … , {φ}_{16} ] = [ \overline{{φ}_{1}} , \overline{{φ}_{2}} , \overline{{φ}_{4}} , \overline{{φ}_{3}} , … , \overline{{φ}_{1}} , \overline{{φ}_{2}} , \overline{{φ}_{4}} , \overline{{φ}_{3}} ] \qquad [ Equation 7 ]$$

$$θ = [ {θ}_{1} , … , {θ}_{16} ] = [ \overline{{θ}_{1}} , \overline{{θ}_{1}} , \overline{{θ}_{1}} , \overline{{θ}_{1}} , … , \overline{{θ}_{4}} , \overline{{θ}_{4}} , \overline{{θ}_{4}} , \overline{{θ}_{4}} ] \qquad [ Equation 8 ]$$

Set of Constellation: S={Q₁, . . . , Q₁₆}={(α̅₁̅, β̅₁̅), . . . , (α̅₁̅₆̅, β̅₁̅₆̅)}

ith Constellation:

$$( \overline{α} \text{?} , \overline{β} \text{?} ) ∈ S where ( \overline{α} \text{?} = cos \text{?} , \overline{β} \text{?} = e \text{?} sin \text{?} ) for l = 1 , … , 16$$

$$\text{?} \text{indicates text missing or illegible when filed}$$

Where (φ₁, θ₁) represents the ith quantized qubit constellation obtained through the optimal quantization on the surface of the Bloch sphere.

# of Constellation: N=|S|=16

Length of Bit Mapping Sequence: B=log₂(N)=4

Condition: |α̅ᵢ̅|²+|β̅ᵢ̅|²=1 for i=1, . . . , 16

$$Set of Bit Sequence = \{ 0000 , ... , 1111 \}$$

Bit Mapping: (Q₁, . . . , Q₁₆)→(0000, . . . , 1111)

The 8-QSM mapping table obtained based on the optimal quantization may be defined/set as shown in Table 12 below.

TABLE 12

| Constellation Index i | Bit Mapping | ( [symbol] ) | ( [symbol] ) |
|---|---|---|---|
| 1 | 0000 | $( \text{?} \frac{\text{?}}{5} )$ | $( cos \frac{\text{?}}{2} \text{?} sin \frac{\text{?}}{2} )$ |
| 2 | 0001 | $( \frac{π}{2} \text{?} \frac{π}{5} )$ | [symbol] |
| 3 | 0010 | $( \frac{\text{?} π}{2} \text{?} \frac{π}{5} )$ | [symbol] |
| 4 | 0011 | $( π , \frac{π}{5} )$ | [symbol] |
| 5 | 0100 | $( 0 , \frac{2 π}{5} )$ | [symbol] |
| 6 | 0101 | $( \frac{π}{2} , \frac{2 π}{5} )$ | [symbol] |
| 7 | 0110 | $( \frac{3 π}{2} , \frac{2 π}{5} )$ | [symbol] |
| 8 | 0111 | $( π , \frac{2 π}{5} )$ | [symbol] |
| 9 | 1000 | $( 0 , \frac{3 π}{5} )$ | [symbol] |
| 10 | 1001 | $( \frac{π}{2} , \frac{3 π}{5} )$ | [symbol] |
| 11 | 1010 | $( \frac{3 π}{2} , \frac{3 π}{5} )$ | [symbol] |
| 12 | 1011 | $( π , \frac{3 π}{5} )$ | [symbol] |
| 13 | 1100 | $( 0 , \frac{3 π}{5} )$ | [symbol] |
| 14 | 1101 | $( \frac{π}{2} , \frac{3 π}{5} )$ | [symbol] |
| 15 | 1110 | $( \frac{3 π}{2} , \frac{3 π}{5} )$ | [symbol] |
| 16 | 1111 | $( π , \frac{3 π}{5} )$ | [symbol] |

[symbol]

indicates data missing or illegible when filed

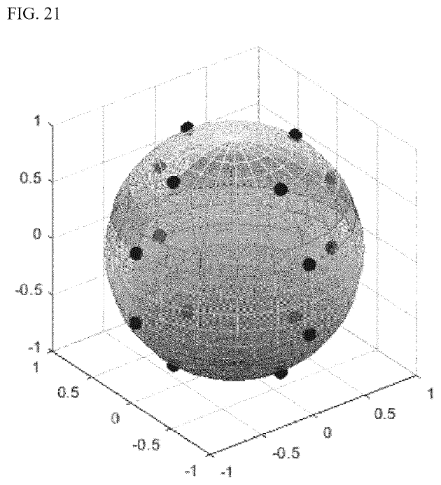

FIG. 21 is a view showing an example of 16-QSM constellations plotted on the surface of the Bloch sphere. Referring to FIG. 21, for the 16-QSM, the Bloch sphere surface may be quantized into sixteen regions.

Alternatively, in order to achieve the gray mapping effect and Euclidean distance maximization simultaneously, the 16-QSM mapping table obtained by quantization configured as φ=[φ₁, . . . , φ₁₆]=[φ̅_̅{̅A̅}̅, φ̅_̅{̅B̅}̅, φ̅_̅{̅A̅}̅, φ̅_̅{̅B̅}̅] may be represented as shown in Table 13 below. Where

$$\overline{{φ}_{A}} = [ \overline{{φ}_{1}} , \overline{{φ}_{2}} , \overline{{φ}_{4}} , \overline{{φ}_{3}} ] and \overline{{φ}_{B}} = [ \overline{{φ}_{1}} , \overline{{φ}_{2}} , \overline{{φ}_{4}} , \overline{{φ}_{3}} ] + \frac{π}{4} .$$

TABLE 13

| Constellation index i | Bit Mapping | ( [symbol] ) | ( [symbol] ) |
|---|---|---|---|
| 1 | 0000 | $( 0 , \frac{π}{5} )$ | $( cos \frac{{θ}_{i}}{2} , {e}^{j {φ}_{i}} sin \frac{{θ}_{i}}{2} )$ |
| 2 | 0001 | $( \frac{π}{2} , \frac{π}{5} )$ | [symbol] |
| 3 | 0010 | $( \frac{3 π}{2} , \frac{π}{5} )$ | [symbol] |
| 4 | 0011 | $( π , \frac{π}{5} )$ | [symbol] |
| 5 | 0100 | $( \frac{π}{4} , \frac{2 π}{5} )$ | [symbol] |
| 6 | 0101 | $( \frac{3 π}{4} , \frac{2 π}{5} )$ | [symbol] |
| 7 | 0110 | $( \frac{7 π}{4} , \frac{2 π}{5} )$ | [symbol] |
| 8 | 0111 | $( \frac{5 π}{4} , \frac{2 π}{5} )$ | [symbol] |
| 9 | 1000 | $( 0 , \frac{3 π}{5} )$ | [symbol] |
| 10 | 1001 | $( \frac{π}{2} , \frac{3 π}{5} )$ | [symbol] |
| 11 | 1010 | $( \frac{3 π}{2} , \frac{3 π}{5} )$ | [symbol] |
| 12 | 1011 | $( π , \frac{3 π}{5} )$ | [symbol] |
| 13 | 1100 | $( \frac{π}{4} , \frac{3 π}{5} )$ | [symbol] |
| 14 | 1101 | $( \frac{3 π}{4} , \frac{3 π}{5} )$ | [symbol] |
| 15 | 1110 | $( \frac{7 π}{4} , \frac{3 π}{5} )$ | [symbol] |
| 16 | 1111 | $( \frac{5 π}{4} , \frac{3 π}{5} )$ | [symbol] |

[symbol]

indicates data missing or illegible when filed

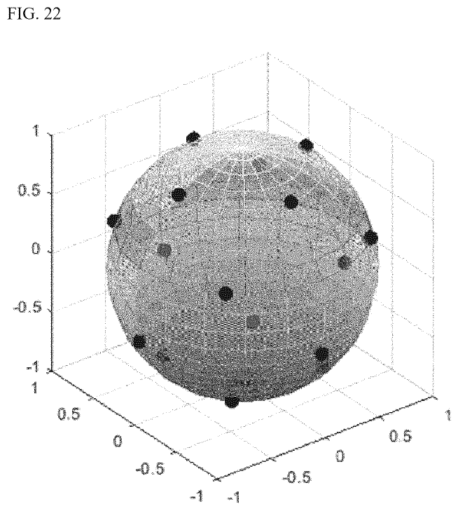

FIG. 22 is a view showing an example of 8-QSM constellations plotted on the surface of the Bloch sphere. Referring to FIG. 22, for the 16-QSM, the Bloch sphere surface may be quantized into sixteen regions.

A 64-QSM table may be configured by such a method.

Through the same method as the method described above, the optimal constellation may be obtained for all Ns, and the N-QSM mapping table may be defined in advance between the transmitting terminal and the receiving terminal. The N-QSM mapping table defined in advance is promised between the transmitting terminal and the receiving terminal. In the N-QSM mapping table defined in advance, an N value for modulation in the transmitting terminal and the receiving terminal may be set, and a step of exchanging information for the N value between the transmitting terminal and the receiving terminal may be performed. More specifically, the transmitting terminal may transmit the information for the value of N to the receiving terminal. Alternatively, the receiving terminal may transmit the information for the value of N to the transmitting terminal.

Afterwards, the transmitting terminal maps the information bits to the quantized qubit constellation based on the set N value, and transmits the qubits generated based on the mapped constellation to the receiving terminal.

Next, the receiving terminal measures the qubit state through quantum state measurement, and decodes the information bits by demapping the constellation based on the set N value.

In the description. N is exemplified for a form of 2\hat{ }B (where B is a non-negative integer), but in a case where N is any integer other than 2\hat{ }B, a constellation arrangement may be designed in a form that optimizes the Euclidean distance of the Bloch sphere. In this case, the N-QSM is not a modulation form that is enabled to be converted into integer bits, but information transmission may be performed from the viewpoint of expressing a state of information to be transmitted. In this case, the transmitting terminal and the receiving terminal must agree in advance on a mapping table of the information state of the integer N-QSM.

Additionally, when the transmitting terminal is a terminal and the receiving is a base station, the information for the value of N may be exchanged between the transmitting terminal and the receiving terminal after a connection between the transmitting terminal and the receiving terminal is formed. Here, the connection may be a radio resource control (RRC) connection. At this time, the information for the value of the N may be transmitted as included in the system information transmitted by the base station to the terminal. Further, the information for the value of the N may be transmitted from the base station to the terminal via an RRC signaling. Here, in order to form the RRC connection, the transmitting terminal may receive a signal for synchronization with the receiving terminal from the receiving terminal. Here, the signal for the synchronization may be a primary synchronization signal (PSS) and/or system information from the receiving terminal. Here, the system information may be information included in a Master Information Block (MIB). Thereafter, the transmitting terminal may perform a random access procedure with the receiving terminal to establish an initial connection to the receiving terminal. Here, the RRC connection between the transmitting terminal and the receiving terminal may be formed based on the random access procedure. Thereafter, the transmitting terminal may receive configuration information from the receiving terminal, and the configuration information may include the value for N. It goes without saying that the described contents may also be applied when the transmitting terminal is the base station and the receiving terminal is the terminal.

QSM based on the Simple Algorithm Approach described above is a method for assigning non-uniform decoding error rates by assigning different Euclidean distances when a bit difference between constellations is 1 and when the bit difference is greater than 1. Therefore, a method in which different decoding methods are used for cases where the bit difference between the constellations is large and small may be a more advantageous modulation scheme. On the other hand, QSM based on the optimal Euclidean distance is a method to assign a uniform decoding error rate by maximizing the minimum Euclidean distance between all any pairs of constellations regardless of the bit difference between the constellations. Therefore, a decoding method based on the Euclidean distance between constellations may be a more advantageous modulation method.

For example, when comparing the Optimal Euclidean Distance-based scheme and the simple algorithm approach-based scheme when M=4, the Euclidean distance between all constellations in the scheme based on the Optimal Euclidean Distance is 1.633. In contrast, the simple algorithm approach-based scheme has a distance of 1.4142 between close constellations and 2 between distant constellations. At this time, in the case of the simple algorithm approach-based scheme, since Gray code mapping is applied, the distance is 1.4142 from the viewpoint of a 1-bit error, and the distance is 2 from the viewpoint of a 2-bit error. Therefore, from the viewpoint of a symbol error, the optimal Euclidean distance-based scheme is always advantageous over the simple algorithm-based scheme. On the other hand, from the viewpoint of the bit error, the simple algorithm approach-based scheme has a trade-off of having a loss from the viewpoint of the 1-bit error and a gain from the viewpoint of the 2-bit error compared to the optimal Euclidean distance-based scheme. The trade-off may result in a difference in decoding performance between the two schemes depending on how both schemes are handled from the viewpoint of decoding. The same applies even when N increases in the same way.

### Quantum State Modulator Design

This method proposes a method for configuring and designing the transmitting terminal of the QSM system.

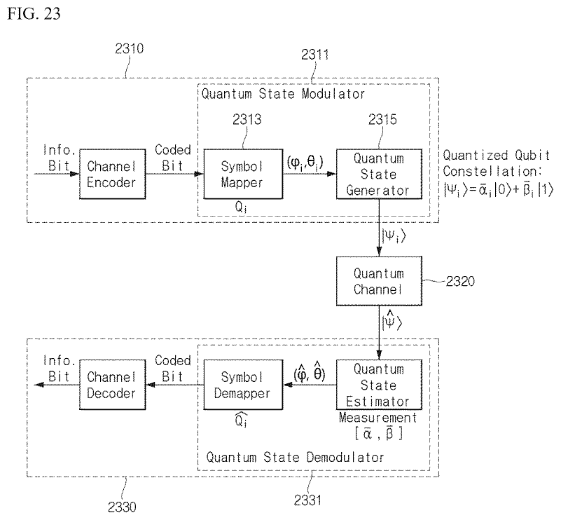

FIG. 23 is a view showing an example of an overall transmitting/receiving terminal structure view of a QSM system.

Referring to FIG. 23, in a system using QSM, a transmitting terminal 2310 modulates classical bit information to be transmitted into a quantized qubit constellation in a quantum state modulator 2311, with or without applying a reliability enhancement technology such as a channel encoder. At this time, the classical bit information is converted into a quantized qubit constellation based on the N-QSM scheme promised between the transmitting terminal and the receiving terminal through the optimal Euclidean distance-based quantum state constellation design scheme described above. Here, the classical bit information may also be converted into a quantized qubit constellation based on the N-QSM scheme promised between the transmitting terminal and the receiving terminal through the simple algorithm approach-based quantum state constellation design scheme described above.

In FIG. 23, the quantum state modulator 2311 includes a symbol mapper 2313 and a quantum state generator 2315.

The symbol mapper 2313 is a logical device that maps classical bit stream information to the quantized qubit constellation Q; based on the optimal Euclidean distance-based N-QSM scheme. Here, the symbol mapper 2313 may also map the classical bit stream information to the quantized qubit constellation Q; based on the simple algorithm approach-based N-QSM scheme.

The quantum state generator 2315 is a physical device that generates the quantized qubit constellation mapped by the symbol mapper 2313 in the quantum state. The quantum state generator 2315 includes a single photon generator and a quantum state controller.

The single photon generator is a device that generate a physical qubit state corresponding to a logical pure state |0 [symbol] or |1 [symbol] by using an initial qubit in order to generate a target qubit state. For example, a horizontal polarization state of a photon is defined as and a vertical polarization state of the photon is defined as |1 [symbol] to physically generate the qubit state. Alternatively, up spin of an electron is defined as |0 [symbol] , and down spin of the electron is defined as |1 [symbol] to physically generate the qubit state.

The quantum state controller is a device that converts an initial qubit state generated by a single photo generator into a qubit state determined by a ball mapper 2313. For example, the quantum state controller may be implemented as a device that controls the probability amplitude in the state of the qubit through a Rabu oscillation which is a phenomenon in which two-level atoms are absorbed, and induced and emitted in a two-level quantum system. Further, the quantum state controller may be configured as a device that controls a phase difference of the qubit state in a phase shift gate of a quantum circuit. Alternatively, in order to perform 3D rotation on the Bloch sphere, the quantum state controller may constitute a device that controls the target qubit state through X, Y, and Z rotation operator gates in which a rotation matrix is applied to a Pauli X, Y, Z gate.

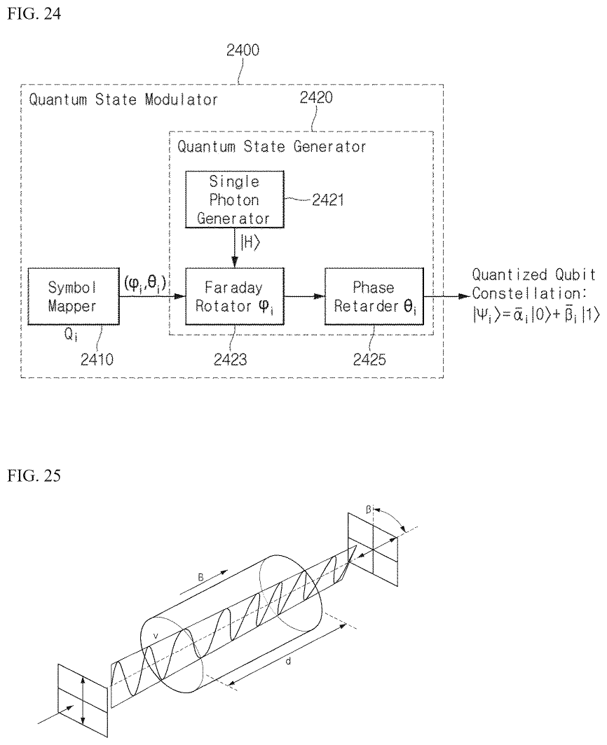

FIG. 24 is a view showing an example of a configuration of a quantum state modulator.

Referring to FIG. 24, a quantum state modulator 2400 may be configured to include a symbol mapper 2410 and a quantum state generator 2420 from the viewpoint of a polarization.

The symbol mapper 2410 is a logical device that maps classical bit stream information to the quantized qubit constellation Q; based on the optimal Euclidean distance-based N-QSM scheme. Here, the symbol mapper 2410 may also map the classical bit stream information to the quantized qubit constellation Q; based on the simple algorithm approach-based N-QSM scheme.

The quantum state generator 2420 is a physical device that generates the quantized qubit constellation mapped by the symbol mapper 2410 in the quantum state. The quantum state generator 2420 includes a single photon generator 2421, a quantum state controller, a Faraday rotator 2423, and a phase retarder 2425.

The single photon generator 2421 is a device that physically configures a logical pure state |0 [symbol] or |1 [symbol] by a polarization for a single photon |H [symbol] or |V [symbol] with an initial qubit for generating a target qubit state. Here, |H [symbol] represents a horizontal linear polarization state, and |V [symbol] represents a vertical linear polarization state.

The single photon generator 2421 may be implemented by a method which generates a light source through CW-Laser, passes only a physical state corresponding to the initial qubit, that is, |H [symbol] or |V [symbol] by a polarizer, and then reduces a quantity of photons up to a single photon level with an attenuator.

The quantum state controller is a device that converts the initial qubit state (e.g., |H [symbol] ) generated by the single photon generator 2421 into the quantum state determined by the symbol mapper 2410. For example, when the initial qubit state is a polarization n |H [symbol] for a single photon, qubit state information φᵢ and θᵢ input by the symbol mapper 2410 is reflected through the Faraday rotator 2423 and the phase retarder 2425 in order to generate the quantized qubit constellation.

FIG. 25 is a view showing an example of a configuration of a Faraday rotator.

Referring to FIG. 25, a Faraday rotator is a device that rotates an axis direction of a polarization based on a Faraday Effect, and when an input polarization is made to pass through a device made of a ferroelectric crystal, a magnetic field is applied to an element, thereby rotating a polarization direction. At this time, a degree of polarization rotation β is determined by a Verdet constant V, which is a characteristic value of the ferroelectric crystal, a flux density B of an applied magnetic field, and a length d of the element.

Referring back to FIG. 24, the Faraday rotator 2423 rotates a single photon polarization |H [symbol] corresponding to the initial qubit state by φᵢ. The rotation of φᵢ means a rotation for a longitude on the Bloch sphere.

The phase retarder 2425 is a wave plate generated based on a birefringent material and is used to convert a linear polarization into a circular polarization. The birefringent material may generate a degree of the circular polarization by utilizing a characteristic that a vertical polarization component corresponding to a y axis passes more slowly than a horizontal polarization component corresponding to an x axis, when a fast axis is the x axis, based on a difference in phase velocity between a reference fast axis and a slow axis.

The phase delay unit 2425 receives an output of the Faraday rotator 2423 that rotates the single photon polarization |H [symbol] corresponding to the initial qubit state by φᵢ and rotates the latitude by θᵢ on the Bloch sphere. Therefore, the initial qubit state generated from the single photon generator 2421 may be converted to a target quantized qubit constellation, |ψᵢ [symbol] =α̅ᵢ̅|0 [symbol] +β̅ᵢ̅|1), according to a relational formula of

$$\text{?} = cos \frac{{θ}_{i}}{2} , \text{?} = \text{?} sin \frac{{θ}_{i}}{2} .$$

$$\text{?} \text{indicates text missing or illegible when filed}$$

At this time, the generated quantized qubit constellation |ψᵢ [symbol] =α̅ᵢ̅|0 [symbol] +β̅ᵢ̅|1) is transmitted to the receiving terminal through the quantum channel.

### Quantum State Demodulator Design

Hereinafter, a method for configuring and designing the receiving terminal of the QSM system is proposed.

Referring back to FIG. 23, a receiving terminal 2330 of the system using the QSM receives a quantized qubit constellation |ψ [symbol] through a quantum channel 2320, and then, a receiving terminal 2330 performs a measurement through quantum state estimation for the quantized qubit constellation in a quantum state demodulator 2331 of the receiving terminal 2330, thereby obtaining a probability amplitude (α̅, β̅) pair.

At this time, the measured (α̅, β̅) pair is decoded based on the N-QSM scheme promised between the transmitting terminal and the receiving terminal through the optimal Euclidean distance-based quantum state constellation design method described above, and classical bit information is obtained at the receiving terminal 2330 with or without applying a reliability enhancement technology such as a channel decoder. Here, the classical bit information may also be decoded, and then obtained based on the N-QSM scheme promised between the transmitting terminal and the receiving terminal through the simple algorithm approach-based quantum state constellation design scheme described above.

### (Hard Decision Case)

Hereinafter, a configuration of a quantum state demodulator in the receiving terminal on hard decision is described.

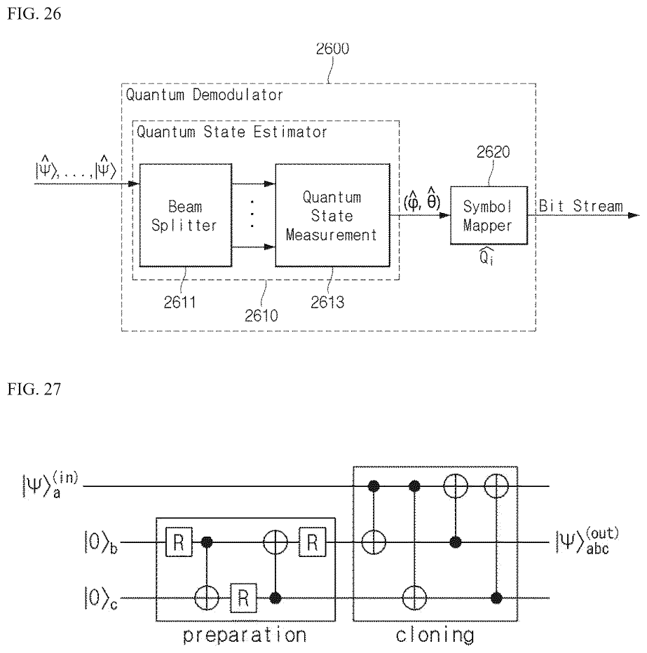

FIG. 26 is a view showing an example of a configuration of a quantum state demodulator in a receiving terminal.

In FIG. 26, a quantum state demodulator 2600 includes a quantum state estimator 2610 and a symbol demapper 2613. Further, the quantum state estimator 2610 includes a beam splitter 2611 and a quantum state measurer 2613.

First, the quantum state estimator 2610 is a physical device that measures the quantum state (here, means a state |φ [symbol] in which the quantized qubit constellation passes through the quantum channel) received by the receiving terminal to obtain the probability amplitude (α̅, β̅) pair.

Here, the probability amplitude (α̅, β̅) is a phenomenon that appears due to a superposition, which is a quantum property, for a pre-promised computation basis, so it is difficult to estimate accurately with a single measurement for a single qubit.

The probability amplitude (α̅, β̅) corresponds 1:1 to the (\hat{φ}, \hat{θ}) pair representing the qubit state on the Bloch Sphere. Therefore, the measurement of the probability amplitude (α̅, β̅) pair representing the qubit state on the Bloch sphere show the same result, although the information obtained by the receiving terminal is expressed differently depending on the measured computation basis. Therefore, the transmitting terminal repeatedly transmits the same qubit state, and the receiving terminal estimates the probability amplitude (α̅, β̅) through repeated measurements on the same qubit state.

Alternatively, the transmitting terminal performs a single transmission for a single qubit state, and the receiving terminal estimates the probability amplitude (α̅, β̅) by repeated measurements via quantum cloning for the single qubit state. At this time, the quantum cloning may not perform Perfect Cloning by a No-cloning Theorem, and thus, incomplete clones may be generated, which may result in a decrease in quantum state estimation performance. On the other hand, there is an advantage of reducing a quantity of physical resources used for qubit transmission since repeated transmission of the transmitting terminal is not required.

When the transmitting terminal transmits a single qubit state and the receiving terminal performs the quantum cloning, the quantum state estimator includes a single photon generator (SPG), a quantum cloning machine, and a quantum state measurer. The single photon generator is a device for generating an initial state of a clone for a received qubit (Original Qubit |ψ̅ [symbol] ).

The quantum cloning machine creates clones |ψ̅ [symbol] for the Original Qubit |ψ̅ [symbol] , and the Original Qubit is also converted to the same |ψ̅ [symbol] state as the Clones. Here, the states of |ψ̅ [symbol] ∝ and |ψ̅ [symbol] are not identical, but similar.

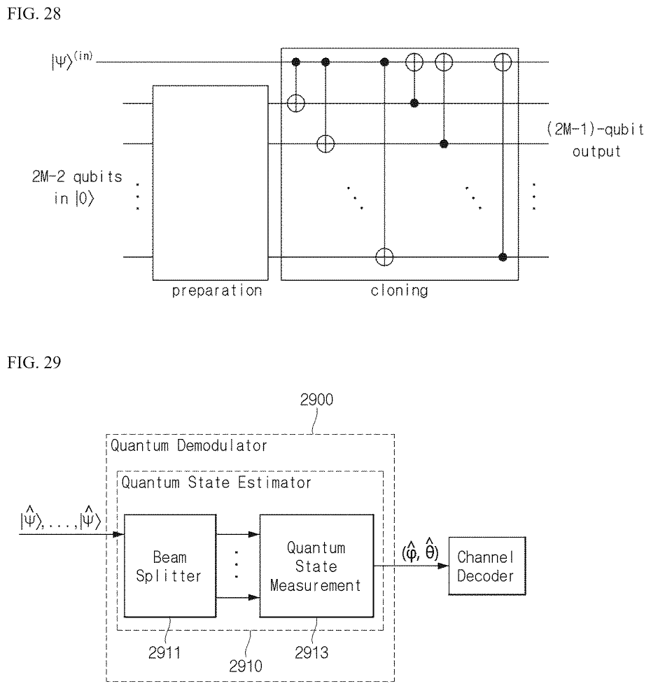

FIGS. 27 and 28 are view showing an example of a quantum cloning scheme.

More specifically, FIG. 27 is a view showing a quantum gate structure of a 1:2 Universal Quantum Cloning Machine (UQCM).

FIG. 28 is a view showing a quantum gate structure of a 1:M Universal Quantum Cloning Machine (UQCM) by generalizing the same scheme as FIG. 27.

The quantum state measurer is a device that measures multiple qubits that are copied similarly in the quantum cloning machine using various computation bases. The quantum state measurer aggregates results measured by using various computation bases and statistically determines a probability amplitude (α̅, β̅) or a pair representing the quantum state on the Bloch sphere.

Alternatively, by combining the two methods, the transmitting terminal performs repeated transmissions for the same quantum state, and the receiving terminal performs more repeated measurements via quantum cloning for multiple identical qubit states, to more accurately estimate the probability amplitude (α̅, β̅).

Referring back to FIG. 26, a symbol demapper 2620 is a logical device that maps pairs representing probability amplitude information or qubit states on the Bloch sphere estimated by the quantum state estimator 2610 to classical bit stream information based on the N-QSM scheme promised between the transmitting terminal and the receiving terminal, through the optimal Euclidean distance-based quantum state constellation design scheme described above. Based on the output (α̅, β̅) or (\hat{φ}, \hat{θ}) pair of the quantum state estimator, a closest constellation index i is selected. Here, the selection of the constellation index is performed by a scheme of selecting the closest constellation index i based on (α̅, β̅) or (\hat{φ}, \hat{θ})) measured in the quantum state estimator and a Euclidean distance between all Constellations (α̅ᵢ̅, β̅ᵢ̅) or (φᵢ, θᵢ) in the N-QSM mapping table. Afterwards, the receiving terminal obtains a classical bit stream mapped to the selected constellation index i. Based on the obtained classical bit stream information, target information bits are obtained with or without applying the reliability enhancement technology such as the channel decoder.

### (Soft Decision Case)

Hereinafter, a configuration of the quantum state demodulator in the receiving terminal on soft decision is described.

FIG. 29 is a view showing an example of the configuration of the quantum state demodulator in the receiving terminal.

In FIG. 29, a quantum state demodulator 2900 includes a quantum state estimator 2910. Further, the quantum state estimator 2910 includes a beam splitter 2911 and a quantum state measurer 2913.

First, the quantum state estimator 2610 is a physical device that measures the quantum state (here, means a state |ψ [symbol] in which the quantized qubit constellation passes through the quantum channel) received by the receiving terminal to obtain the probability amplitude (α̅, β̅) pair.

Here, the probability amplitude (α̅, β̅) is a phenomenon that appears due to a superposition, which is a quantum property, for a pre-promised computation basis, so it is difficult to estimate accurately with a single measurement for a single qubit.

The probability amplitude (α̅, β̅) corresponds 1:1 to the pair representing the qubit state on the Bloch Sphere. Therefore, the measurement of the probability amplitude (α̅, β̅) and the measurement of the (\hat{φ}, \hat{θ}) pair representing the qubit state on the Bloch sphere show the same result, although the information obtained by the receiving terminal is expressed differently depending on the measured computation basis. Therefore, similar to the hard decision case, the transmitting terminal repeatedly transmits the same qubit state, and the receiving terminal estimates the probability amplitude (α̅, β̅) through repeated measurements on the same qubit state.

When the transmitting terminal performs the repeated transmissions for the same qubit state, the quantum state estimator 2910 of the receiving terminal is constituted by the beam splitter 2911 and the quantum state measurer 2913. The beam splitter 2611 is a device that probabilistically splits received qubits. The quantum state measurer 2613 is a device that measures the qubits split from the beam splitter 2611 using various computation bases. The quantum state measurer 2613 aggregates results measured by using various computation bases and statistically determines a probability amplitude (α̅, β̅) or a (\hat{φ}, \hat{θ}) pair representing the quantum state on the Bloch sphere.

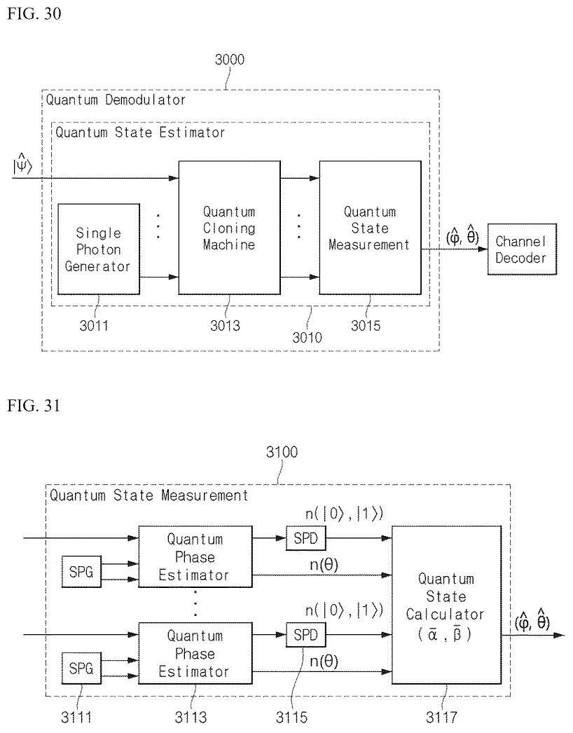

FIG. 30 is a view showing another example of the configuration of the quantum state demodulator in the receiving terminal. FIG. 30 related to a case where the transmitting terminal performs a single transmission for a single qubit state, and the receiving terminal estimates the probability amplitude (α̅, β̅) by repeated measurements via quantum cloning for the single qubit state.

When the transmitting terminal transmits a single qubit state and the receiving terminal performs the quantum cloning, the quantum state estimator 3010 includes a single photon generator (SPG) 3011, a quantum cloning machine 3013, and a quantum state measurer 3015. The single photon generator is a device for generating an initial state of a clone for a received qubit (Original Qubit |\hat{φ} [symbol] ).

In the soft decision case, unlike the hard decision case, the probability amplitude information estimated by the quantum state estimator is input to the channel decoder without determining the classical bit stream through the symbol demapper, or the Soft Value of the (α̅, β̅) and a (\hat{φ}, \hat{θ}) pair representing the qubit state on the Bloch sphere is input. Channel decoding is performed by calculating a Log-likelihood Ratio (LLR) according to the configuration of the channel decoder for the soft values of probability amplitude information (α̅, β̅) estimated by the quantum state estimator and the (\hat{φ}, \hat{θ}) pair representing the quantum state on the Bloch sphere.

In the quantum state estimator of the quantum decoder, the quantum state measurer may be configured depending on the measured qubit state. More specifically, when computation bases |0 [symbol] and |1 [symbol] are measured by a single photon detector for measurement of the quantum state, it is possible to measure for |α̅↑² and |β̅|² which are square values of the probability amplitudes for |ψ̅ [symbol] (or |ψ̅ [symbol] )), but it is not possible to find out values of α̅ and β̅ themselves. From the viewpoint of the Bloch sphere, a ratio of α̅ and β̅ may be calculated by measuring |α̅|² and |β̅|², so may be measured, but φ̅, which is a phase difference between \hat{α} and β̅ may not be measured. Therefore, the quantum state measurer consists of a device for measuring |α̅|² and |β̅|² and a device for measuring the phase difference between α̅ and β̅.

FIG. 31 is a view showing an example of a configuration of a quantum state estimator of a quantum decoder.

Referring to FIG. 31, a quantum state estimator 3110 may calculate # and @ in a quantum state calculator 3117 through a quantum phase estimator 3113 and a single photon detector (SPD) 3115 that counts a computation basis.

\hat{α} and β̅ calculated by the quantum state calculator 3117 may be converted into a soft value of the (\hat{φ}, \hat{θ}) pair representing the qubit state from the viewpoint of the Bloch sphere. In a system where the transmitting terminal repeatedly transmits multiple identical qubits, the SPD may be replaced by a general photo detector (PD), and in this case, the SPD may be replaced with a scheme of measuring intensities of photons other than a scheme of counting the photon.

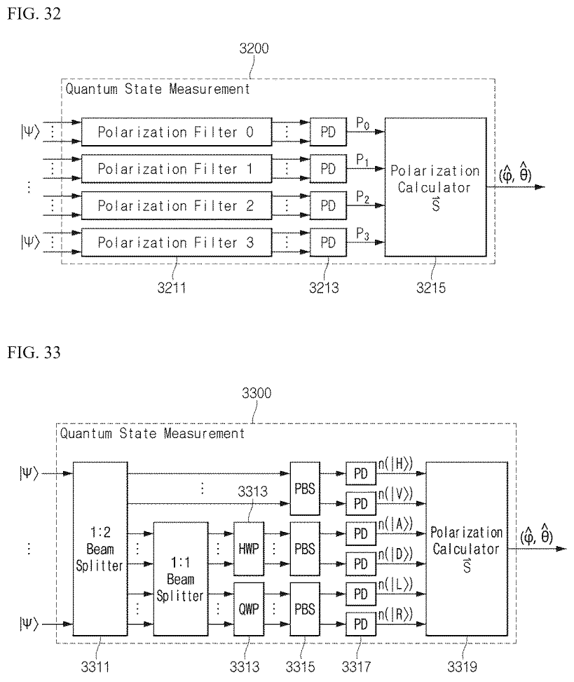

FIG. 32 is a view showing still yet another example of the configuration of the quantum state estimator of the quantum decoder. FIG. 32 relates to a case where a qubit to be measured uses a computation basis based on a polarization.

After performing parallelism on multiple qubits through repeated transmission or quantum cloning of the transmitting terminal, when the qubits are input to the quantum state measurer 3200 of the receiving terminal, powers measured by passing through four polarization filters 3211 and a photon detector 3213 may be expressed as P₀, P₁, P₂, P₃, respectively.

Here, polarizing filter 0 consists of a horizontal polarizer, polarizing filter 1 consists of a vertical polarizer, polarizing filter 2 consists of a +45 linear polarizer, and polarizing filter 3 consists of a Quarter-waveplate (QWP) and a +45 linear polarizer. The four Powers P₀, P₁, P₂, P₃ obtained through this polarization filter configuration may be obtained as Stokes parameters by Equation 9 below in a polarization calculator.

$${S}_{0} = {P}_{0} + {P}_{1} \qquad [ Equation 9 ]$$

$${S}_{1} = {P}_{0} - {P}_{1}$$

$${S}_{2} = 2 {P}_{2} - {P}_{0} - {P}_{1}$$

$${S}_{3} = 2 {P}_{3} - {P}_{0} - {P}_{1}$$

FIG. 33 is a view showing still yet another example of the configuration of the quantum state estimator of the quantum decoder.

Referring to FIG. 33, when parallelism on multiple qubits through repeated transmission or quantum cloning of the transmitting terminal is performed, and then the qubits are input to the quantum state measurer 3300 of the receiving terminal, the qubits pass through a beam splitter 33111, a half-wave plate (HWP) 3313, a quarter-wave plate (QWP) 3314, and a polarization beam splitter (PBS) 3315, and as a result, six operational bases |H [symbol] , |V [symbol] , |D [symbol] , |A [symbol] , |L [symbol] , |R [symbol] may be measured. Here, |D [symbol] means a +45 linear polarization in a diagonal basis. |A [symbol] means a −45 linear polarization in an anti-diagonal basis, |L [symbol] means a left circular polarization, and |R [symbol] means a right circular polarization. Countings (or powers) n(|H [symbol] ), n(|V [symbol] ), n(|D [symbol] ), n(|A [symbol] ), n(|L [symbol] ), n(R [symbol] ) of six computation bases obtained by the configuration may be obtained as stokes parameters by Equation 10 below in the polarization calculator 3319.

$${S}_{0} = n ( \vert H 〉 ) + n ( \vert V 〉 ) = n ( \vert D 〉 ) + n ( \vert A 〉 ) = n ( \vert L 〉 ) + n ( \vert R 〉 ) \qquad [ Equation 10 ]$$

$${S}_{1} = n ( \vert H 〉 ) - n ( \vert V 〉 )$$

$${S}_{2} = n ( \vert D 〉 ) - n ( \vert A 〉 )$$

$${S}_{3} = n ( \vert R 〉 ) - n ( \vert L 〉 )$$

In the description, the measurement of polarization on the Bloch sphere is represented by the measurement of the stoke parameter, and the (\hat{φ}, \hat{θ}) pair representing the qubit state from the viewpoint of the Bloch sphere may be calculated by the following equation.

$$\hat{φ} = arctan ( \frac{{S}_{2}}{{S}_{1}} ) \qquad [ Equation 11 ]$$

$$\hat{θ} = arctan ( \frac{{S}_{3}}{\sqrt{{{S}_{1}}^{2} + {{S}_{2}}^{2}}} )$$

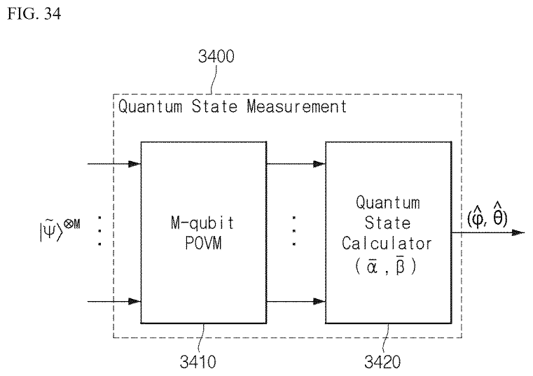

FIG. 34 is a view showing still yet another example of the configuration of the quantum state estimator of the quantum decoder. FIG. 34 is a view related to a case where multiple clones are in an entangled state through quantum cloning. Referring to FIG. 34, a quantum decoder 3400 includes a Positive Operator Valued Measurement (POVM) 3410 and a quantum state calculator 3420 that measure an M-qubit state |\tilde{ψ} [symbol] ^{⊗M} in which M clones are directly produced. The M-qubit POVM 3410 is not a measurement on individual clones, but rather a measurement performed on the entangled state of M clones at once. Therefore, assuming that measurements through L computation bases are required for one qubit measurement, the qubit state may be estimated by performing POVM measurements corresponding to LM at once. For example, when POVM operators {μ₀, μ₁, μ₂, μ₃} are defined for the measurement of the stoke parameters S₀, S₁, S₂, S₃ for a single-qubit measurement, the qubit state is estimated by performing POVM measurements corresponding to 4² as {μ₀μ₀, μ₀μ₁, . . . , μ₃μ₃} at once for a 2-qubit (two-qubit) measurement.

By counting the measurements through each operator via POVM operators {μ₀μ₀, μ₀μ₁, . . . , μ₃μ₃} for the 2-qubit measurement, a density matrix for the 2-qubit state may be reconstructed, and the probability amplitude information (α̅, β̅) for the qubit state may be obtained based on the density matrix for the 2-qubit state. At this time, as the number of entangled qubits increases, the qubit state may be estimated by performing a POVM measurement corresponding to 4^{M}.

It is apparent that the quantum state proposed by the present disclosure may be applied to all quantum states that are enabled to be expressed in probability amplitudes based on the superposition property of the quantum. At this time, the quantum superposition state includes all quantum states in which two states probabilistically coexist before measurement from the viewpoint of the two-level computation basis. For example, when the quantum state is defined by constructing a two-level computation basis based on each of time, phase, polarization, etc., it is apparent that the N-QSM scheme of the defined Bloch viewpoint is applicable. It is apparent that the quantum state is applicable to all particle units with quantum properties, such as photons and electrons, which correspond to smallest units of physical quantities.

### Effects

According to the proposed methods of the present disclosure described above, there is an effect of enabling transmission of classical 1-bit information or more though a single qubit composed of a two-dimensional Hilbert space.

More specifically, it is able to transmit N qubit states or log 2(N) bits by using a single qubit through N-QSM.

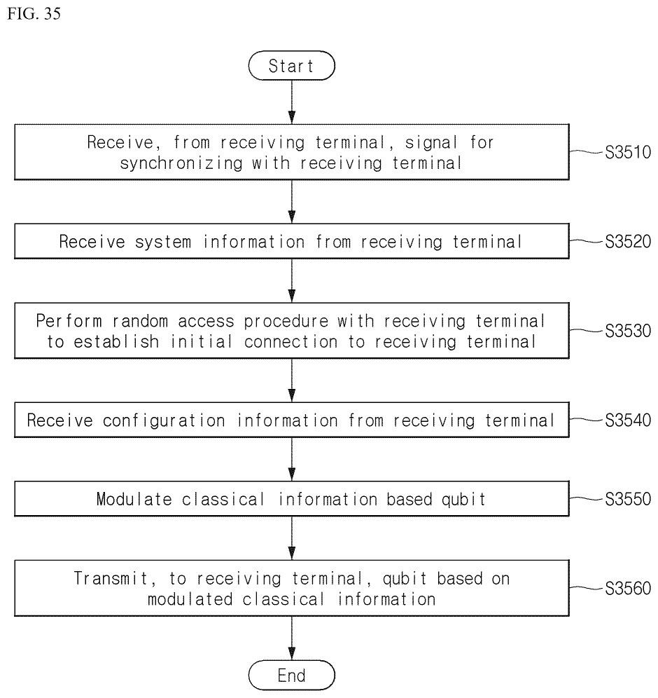

FIG. 35 is a flowchart showing an example in which an information transmission method proposed by the present disclosure is performed by a transmitting terminal.

More specifically, in order for the transmitting terminal to transmit information in a quantum communication system, the transmitting terminal receives a signal for synchronization with the receiving terminal from the receiving terminal (S3510).

Next, the transmitting terminal receives system information from the receiving terminal (S3520).

Next, the transmitting terminal performs a random access procedure with the receiving terminal to establish an initial connection to the receiving terminal (S3530).

Next, the transmitting terminal receives configuration information from the receiving terminal (S3540).

Here, the configuration information including information for the number of quantized qubit states obtained by quantizing states of qubits for transmission of classical information.

Next, the transmitting terminal modulates the classical information based on the qubit (S3550). Here, the classical information is modulated based on a predefined mapping relationship based on (i) the classical information and (ii) the state of the qubit, and the mapping relationship includes mapping relationships between (i) bit values that the classical information may have and (ii) the quantized qubit states.

Thereafter, the transmitting terminal transmits the qubit based on the modulated classical information to the transmitting terminal (S3560).

Further, the transmitting terminal includes: a transmitter for transmitting a radio signal; a receiver for receiving the radio signal; at least one processor; and at least one computer memory operably connectable to the at least one processor, and storing instructions of performing operations when executed by the at least one processor. At this time, the operations include the steps described in FIG. 35 above.

Further, the operations described in FIG. 35 may be stored in a non-transitory computer readable medium (CRM) storing one or more instructions. The non-transitory computer readable medium (CRM) store one or more instructions executable by one or more processors, and the one or more instructions allow the transmitting terminal to perform the operations described in FIG. 35.

Further, in a device including one or more memories, and one or more processor functionally connected to the one or more memories, the one or more processors control the device to perform the operations described in FIG. 35.

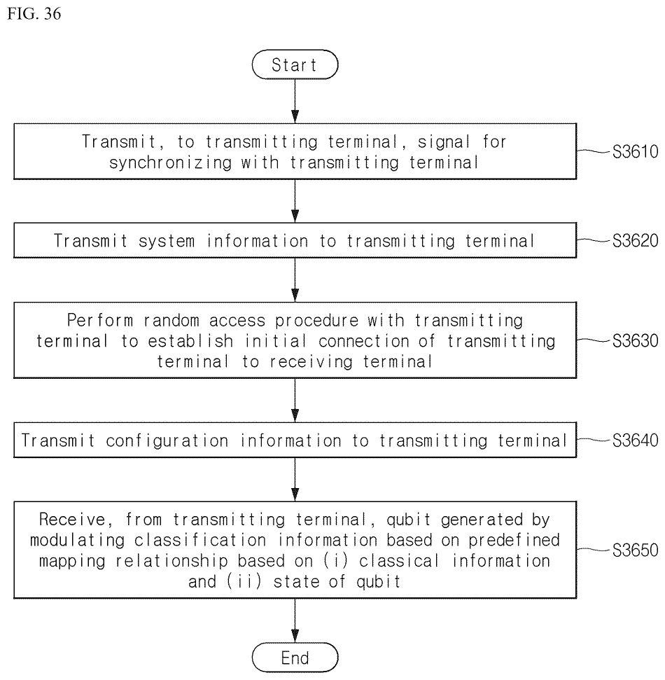

FIG. 36 is a flowchart showing an example in which the information transmission method proposed by the present disclosure is performed by a receiving terminal.

In a quantum communication system, in order for a receiving terminal to receive information, the receiving terminal transmits, to a transmitting terminal, a signal for synchronizing with the transmitting terminal (S3610).

Next, the receiving terminal transmits system information to the transmitting terminal (S3620).

Next, the receiving terminal performs a random access procedure with the receiving terminal to establish an initial connection to the transmitting terminal (S3630).

Thereafter, the receiving terminal transmits configuration information to the transmitting terminal (S3640).

Here, the configuration information including information for the number of quantized qubit states obtained by quantizing states of qubits for transmission of classical information.

Thereafter, the transmitting terminal receives, from the transmitting terminal, the qubit generated by modulating the classification information based on a predefined mapping relationship based on (i) the classical information and (ii) the states of the qubits (S3650). Here, the mapping relationship includes mapping relationships between (i) bit values that the classical information may have and (ii) the quantized qubit states.

Further, the receiving terminal includes: a transmitter for transmitting a radio signal; a receiver for receiving the radio signal; at least one processor; and at least one computer memory operably connectable to the at least one processor, and storing instructions of performing operations when executed by the at least one processor. At this time, the operations include the steps described in FIG. 36 above.

Further, the operations described in FIG. 36 may be stored in a non-transitory computer readable medium (CRM) storing one or more instructions. The non-transitory computer readable medium (CRM) stores one or more instructions executable by one or more processors, and the one or more instructions allow the receiving terminal to perform the operations described in FIG. 2/36.

Further, in a device including one or more memories, and one or more processor functionally connected to the one or more memories, the one or more processors control the device to perform the operations described in FIG. 36.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL AVAILABILITY

The present disclosure is described based on an example applied to the 3GPP LTE/LTE-A system and the 5G system, but it is possible to apply the present disclosure to various wireless communication systems in addition to the 3GPP LTE/LTE-A system and the 5G system.

1. A method comprising:
receiving, from a receiving terminal, a signal for synchronizing with the receiving terminal;
receiving system information from the receiving terminal;
performing a random access procedure with the receiving terminal to establish an initial connection to the receiving terminal;
receiving configuration information from the receiving terminal,
the configuration information including information for the number of quantized qubit states obtained by quantizing state of qubit for transmission of classical information;
modulating the classical information based on the qubit,
the classical information being modulated based on a predefined mapping relationship based on (i) the classical information and (ii) the state of the qubit, and
wherein the mapping relationship includes mapping relationships between (i) bit values that the classical information may have and (ii) the quantized qubit states; and
transmitting, to the receiving terminal, the qubit based on the modulated classical information.

2. The method of claim 1, wherein the state of the qubit is determined based on a first qubit basis and a second qubit basis.

3. The method of claim 2, wherein the first qubit basis is multiplied by a real value, and the second qubit basis is multiplied by an imaginary value.

4. The method of claim 3, wherein a pair of (i) the real value multiplied by the first qubit basis and (ii) the imaginary value multiplied by the second qubit basis are defined to be located on a surface of a sphere in a three-dimensional space.

5. The method of claim 4, wherein the mapping relationship is a mapping relationship between (i) pairs of the real value and the imaginary value, and (ii) the bit values that the classical information may have.

6. The method of claim 1, wherein the number of the quantized qubit states is N, and
wherein the N is a non-negative integer.

7. The method of claim 6, further comprising:
exchanging information for the N with the receiving terminal.

8. The method of claim 7, wherein the modulating the classical information based on the qubit for transmitting the classical information is performed based on the information for the N.

9. The method of claim 8, wherein the exchanging the information for the N with the receiving terminal comprises:
transmitting the information for the N to the receiving terminal.

10. The method of claim 8, wherein the exchanging the information for the N with the receiving terminal comprises:
receiving the configuration information, and
wherein the information for the N is included in the configuration information.

11. A transmitting terminal comprising:
a transmitter for transmitting a radio signal;
a receiver for receiving the radio signal;
at least one processor; and
at least one computer memory operably connectable to the at least one processor, and storing instructions of performing operations when executed by the at least one processor,
wherein the operations comprise:
receiving, from a receiving terminal, a signal for synchronizing with the receiving terminal;
receiving system information from the receiving terminal;
performing a random access procedure with the receiving terminal to establish an initial connection to the receiving terminal;
receiving configuration information from the receiving terminal,
the configuration information including information for the number of quantized qubit states obtained by quantizing state of qubit for transmission of classical information;
modulating the classical information based on the qubit,
the classical information being modulated based on a predefined mapping relationship based on (i) the classical information and (ii) the state of the qubit, and
wherein the mapping relationship includes mapping relationships between (i) bit values that the classical information may have and (ii) the quantized qubit states; and
transmitting, to the receiving terminal, the qubit based on the modulated classical information.

12. (canceled)

13. A receiving terminal comprising:
a transmitter for transmitting a radio signal;
a receiver for receiving the radio signal;
at least one processor; and
at least one computer memory operably connectable to the at least one processor, and storing instructions of performing operations when executed by the at least one processor,
wherein the operations comprise:
transmitting, to a transmitting terminal, a signal for synchronizing with the transmitting terminal;
transmitting system information to the transmitting terminal;
performing a random access procedure with the transmitting terminal to establish an initial connection of the transmitting terminal to receiving terminal;
transmitting configuration information to the transmitting terminal,
the configuration information including information for the number of quantized qubit states obtained by quantizing state of qubit for transmission of classical information; and
receiving, from the transmitting terminal, the qubit generated by modulating the classification information based on a predefined mapping relationship based on (i) the classical information and (ii) the state of the qubit,
wherein the mapping relationship includes mapping relationships between (i) bit values that the classical information may have and (ii) the quantized qubit states.

14-15. (canceled)
